(19) United States
(12) Patent Application Publication
(10) Pub. No.: US 2025/0252713 A1
(43) Pub. Date: Aug. 7, 2025

(54) SYSTEMS AND METHODS FOR TRAINING MACHINE LEARNING MODELS USING EMULATED DATASETS

(71) Applicant: Amazon Technologies, Inc., Seattle, WA (US)

(72) Inventors: Alessandro Achille, Arcadia, CA (US); Aditya Sharad Golatkar, Los Angeles, CA (US); Benjamin Howard Bowman, Los Angeles, CA (US); Michael Kearns, Philadelphia, PA (US); Carson Klingenberg, Bainbridge Island, WA (US); Stefano Soatto, Pasadena, CA (US)

(73) Assignee: Amazon Technologies, Inc., Seattle, WA (US)

(21) Appl. No.: 18/434,291

(22) Filed: Feb. 6, 2024

(51) Int. Cl. G06V 10/774; G06V 10/74

(52) U.S. Cl. CPC G06V 10/774; G06V 10/761

(57) ABSTRACT

Systems and methods for training machine learning models using emulated datasets are provided. In some instances, it may be undesirable for certain portions of an initial training dataset to be used to train a machine learning model. In other instances, a model may be trained using an initial training dataset and it may be desired to cause the machine learning model to “forget” certain aspects of the training. To address both of these scenarios, a generative machine learning model may be used to generate an emulated training dataset that is based on the initial training dataset. The emulated training dataset is then used to train the machine learning model that is ultimately used to perform downstream tasks. This allows the machine learning model to still be trained to perform the task, without the risk of the machine learning model being exposed to the portions of the training data that are undesired to be used for training.

### BACKGROUND

Responsible use of data is an indispensable part of any machine learning implementation. Machine learning developers must carefully collect and curate their datasets, and document their provenance. Over the past few years, machine learning models have significantly increased in size and complexity. These models require a very large amount of data and compute capacity to train, to the extent that any defects in the training corpus cannot be trivially remedied by retraining the model from scratch. Despite sophisticated controls on training data and a significant amount of effort dedicated to ensuring that training datasets are properly composed, the sheer volume of data required for the models makes it challenging to manually inspect each datum comprising a training dataset.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral may identify the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may depending on the context, encompass a plural number of such components or elements and vice versa.

FIG. 1 depicts a flow diagram for training a machine learning model using an emulated dataset in accordance with one or more example embodiments of the disclosure.

FIG. 2 depicts another flow diagram for training a machine learning model using an emulated dataset in accordance with one or more example embodiments of the disclosure.

FIG. 3 depicts another flow diagram for training a machine learning model using an emulated dataset in accordance with one or more example embodiments of the disclosure.

FIG. 4 depicts an example use case for training a machine learning model using an emulated dataset in accordance with one or more example embodiments of the disclosure.

FIG. 5 depicts a method for training a machine learning model using an emulated dataset in accordance with one or more example embodiments of the disclosure.

FIG. 6 depicts another method for training a machine learning model using an emulated dataset in accordance with one or more example embodiments of the disclosure.

FIG. 7 depicts an example system for training a machine learning model using an emulated dataset in accordance with one or more example embodiments of the disclosure.

FIG. 8 depicts an example computing device in accordance with one or more example embodiments of the disclosure.

### DETAILED DESCRIPTION

This disclosure relates to, among other things, systems and methods for training machine learning models using emulated datasets. Particularly, the systems and methods provide a “clean room setting” for training models that involves beginning with an initial dataset, generating an abstract description of that dataset (for example, in the form of text descriptions or features), and then generating, based on the abstract description, a new synthetic “emulated” dataset (for example, using a generative model). That is, the emulated dataset may be training data that is generated by a model in contrast with the real initial training dataset. The emulated dataset may then be used in place of the original dataset to train new models. The emulated dataset may also be generated in any other suitable manner described herein or otherwise (other than based on an abstract description). The use of the emulated dataset in place of the initial dataset is an improvement to the machine learning training process because it provides a separation that ensures that the initial data is not seen by the model being trained. This is beneficial if the initial dataset includes some sensitive data, such as personally-identifiable information, for example.

As an example, diffusion models are a type of generative machine learning model that generates output images based on simple text prompts or sketches. However, in some cases, these diffusion models may capture the personal workmanship of artists, given that the sheer volume of training data makes it challenging to verify the attribution of each sample of the training data.

As aforementioned, the manner in which training data is used to train a model is critical for a number of reasons. One potential solution for training corpus data defects is model disgorgement, or the elimination of not just the improperly used data, but also the effects of improperly used data on any component of a model. Model disgorgement techniques may be used to address a wide range of issues, such as reducing bias or toxicity, increasing fidelity, and ensuring responsible usage of intellectual property.

One of the core challenges with model disgorgement for large models is that these models may include parameters representing an arbitrarily high number of data dimensions and statistical correlations. This means that it may be difficult to determine the specific effect that any particular piece of training data had on a fully trained model. For at least this reason, it may not be a viable strategy to simply delete the data associated with the model. A number of different approaches for performing model disgorgement are described herein, including at least reactive disgorgement (including retraining and forgetting/unlearning), proactive disgorgement (including compartmentalization), and preemptive disgorgement (including dataset emulation and differential privacy). The systems and methods described herein, however, may use one or a combination of dataset emulation and compartmentalization.

Beginning with reactive disgorgement, large-scale neural networks may be trained on datasets that include web-scale data. In such cases, the need for model disgorgement may arise from, among other things, errors in the data collection and curation process.

A first reactive disgorgement approach may include retraining the model. Retraining is a method used to remove the influence of any cohort of data from a trained model by simply retaining the model again using only the remaining data. However, considering that machine learning models currently in use can have hundreds of billions or even trillions of parameters, retraining the model after each model disgorgement request may not be a viable approach. Apart from cost considerations, when the model is used as part of a workflow in a larger system, the retrained model is generally not compatible with the original model. Slight perturbations of the training process, even if retraining the same model on the same data, may yield models whose behavior is sufficiently different to disrupt the behavior of downstream workflows. Thus, model disgorgement based on retraining may render most large-scale model systems unusable.

A second reactive disgorgement approach may include selective forgetting and/or unlearning. If the cohort of data that triggers the need for model disgorgement is a small fraction of the overall training data, it may be possible to characterize and eliminate its influence on the trained model without the need to retrain the model. Due to the complexity of large-scale deep networks, estimating the influence of a sample in a way that is simultaneously efficient and precise is challenging. Hence, such procedures may not provide deterministic removal guarantees, but can provide quantifiable probabilistic measures. Many approaches to unlearning are based on the notion of influence functions, which provide methods to efficiently estimate the influence of selected samples through an approximation of the loss function used to train the model. Such probabilistic measures, however, may fail when applied to large-scale deep networks due to the complexity of the training process and the highly non-convex nature of the loss function. Some of these challenges can be mitigated if the developer of the model has at its disposal a “safe core” set of training data that is known to never require disgorgement, for instance, synthetic data generated ab ovo. In particular, the safe core set can be used to initialize the model, and information from additional data can be encoded as a small perturbation of the core model. This allows for the influence of additional data to be more easily estimated, and to remove their influence if needed without catastrophic consequences to the overall model.

Turning to preemptive disgorgement, modifications to the training process may be performed that, by design, ensure that “unique information” contained in any cohort of samples in the training data is bounded by a small value, which may be selected by a user or automatically selected by the system. Given that no substantial information about any training sample is present in the model, the model may theoretically be left untouched and still satisfy an individual disgorgement request. However, disgorgement of larger groups of data may still present a challenge.

A first preemptive disgorgement approach is differential privacy. Differential privacy involves proactively training a model in a way that no particular piece of training data has more than a negligible effect on the model or the content it generates. Beginning with the initial training dataset D and the dataset D′ that results from removing any small fraction of D (As one non-limiting example, all the works of a particular artist). Then under differential privacy, a model trained on D is statistically indistinguishable from one trained on D′ even to an observer (or system) who knows both D and D′. In the generative setting, this means the distribution over output content for a given input prompt is also indistinguishable. In other words, a differential privacy model effectively disgorges training data by minimizing its effects a priori.

Differential privacy models are achieved by deliberately adding noise to the training process in a way that attempts to eradicate the impact of any small piece of the data while still having the desired aggregate effects (in generative models, high-quality outputs). Adding more noise provides stronger disgorgement properties but may also degrade the output quality of the model. This trade-off is determined by a privacy parameter that may be selected by a user or automatically determined by the system.

A second preemptive disgorgement approach is dataset emulation, which is used by the methods described herein. Some disgorgement requests arise in the context of “generative artificial intelligence,” where the concern is that the model may generate data that is “similar to,” “in the style of,” or “captures the spirit of” data used for training. The goal of dataset emulation is to generate a synthetic “emulated” dataset “Dₑₘ” that captures the general distributional properties of the original training set “D,” while maximizing the geometric, perceptual, or conceptual distance from D.

While a dataset Dₑₘ generated from a model trained on D has a computational relationship with the D, in some instances, that relationship may be limited to capture general distributional properties while exercising maximum care to steer clear of generating samples close to D. Once such a guarantee is provided, the data Dₑₘ may be usable in downstream tasks without implicating the protectable elements of D. In particular, the resulting data may be used to train a model, now without constraints, that can be used to discriminate or generate new outputs D_{gen}. In the latter case, the emulated dataset Dₑₘ acts as a “clean room” to separate the model that generates D_{gen} from the dataset D, which not only has never been seen by the model that produces D_{gen}, but which has samples that are, by design, as different as possible from D_{gen}. If desired, users may manually inspect Dₑₘ to ensure that transferred elements are not contained in Dₑₘ, or that it is sufficiently different, before the final model is trained. This verification may also automatically be performed by the system rather than requiring manual user inspection.

When generating Dₑₘ, there are infinitely many models that could be trained on D, each involving design choices and randomness, and each able to generate essentially infinitely many different datasets Dₑₘ. While a model trained on Dₑₘ may contain significant novel elements, the owner of D may still want to protect specific aspects implicit in D. These aspects may be measured directly on each sample of the emulated dataset Dₑₘ and removed automatically or manually so that the Dₑₘ is guaranteed to not have such information. Alternatively, a generative model trained on D may be used to create synthetic data Dₑₘ that structurally is biased to differ as much as possible from D on these specific aspects.

In embodiments, this bias may be hard-coded in a loss function used to train the model, rather than being verified from the output of the model. This may be achieved by training the generative model while also maximizing a distance d(x, x′) between the generated samples x′ and the training samples x. The same distance may be used to reject generated samples post hoc as an additional measure, for instance, if d(x, x′)<ε for a tunable ε.

Training a generative model on entirely synthetic data, however, may remain technically challenging even if the images in Dₑₘ are realistic and subjectively “similar” to those in D, the quality of a model trained on Dₑₘ is typically substantially degraded compared to one trained on D. This is because synthetically generated images, even when realistic, may include subtle artifacts that affect the training process. Such artifacts impact the quality of both generative and discriminative models, sometimes referred to as the “sim-to-real gap.” This sim-to-real gap may be improved by using higher quality data (for example, the if the data is images, the images may be higher resolution images, etc.).

Another option is for Dₑₘ to be generated in a different modality than D. For example, Dₑₘ may include restricted abstract encodings (embedding vectors not directly renderable as images), or encodings mapped to semantically interpretable values, for instance captions or text embeddings. In this case, the value of the emulated dataset for downstream training is even further reduced.

With respect to the distance that may be used, for symbolic data such as text (represented either in raw form or as a vector embedding “x”), there are objective (“geometric”) distances d_{g}(x₁, x₂)=∥x₂−x₁∥p that well approximate perceived similarity. However, for signal data such as images, any datum x₁ has a large number of samples that are far from x₁ according to d_{g}, yet are perceptually indistinguishable. This can occur both for subtle changes or for macroscopic ones. The value of every pixel may be changed in an image without triggering a perceptible change. To capture perceptual, rather than geometric, similarity, low-level statistics ϕ designed to mimic the early stages of human cortical processing may be compared, designed so that data points that have small distances are effectively (with high probability) indistinguishable by humans. In this case, the “perceptual distance” may be written as dₚ(x₁, x₂)=∥ϕ(x₁)−ϕ(x₂)∥ which shifts the comparison from data space to feature space, where a standard geometric distance is applied. Beyond a pre-designed feature space that depends on the sensor but not the object being sensed, the abstract concept of “style” or “spirit” of a certain dataset may be considered. In this case, not a geometric distance d_{g} or perceptual distance dₚ, but rather a “conceptual distance” d_{c}(x₁, x₂)=∥(x₁)−(x₂)∥ may be defined where now ψ is no longer designed to capture low-level statistics, but rather it is trained to capture high-level semantic characteristics of the data. For instance, ψ can be the embedding produced by a model trained to align images and their corresponding textual explanations, or “captions.”

The choice of distance defines what is to be considered tantamount to reproduction of the data beyond verbatim reproduction of the data itself. If the distance is too large, it may cover a portion of data space far beyond the original data, possibly including data belonging to other owners. For example, an entity that owns dataset D may be interested in licensing the dataset for training to a service provider who already has a model trained on the dataset Dₑₘ. The entity may require that all data generated be farther than some r>0 from D according to an adversarial chosen distance d. If the images already generated by the service fall within a distance r, despite having been obtained without any knowledge of D, then the owner of D may be attempting to control the usage of data that does not belong to them. Thus, the validity of the exercise falls in the choice of the distance or discriminant that determines protectable elements of the data D. Such a distance or discriminant may need to be carefully tested and calibrated so as not result in over-reaching. Even so, a distance could be fooled into misclassifying data as being sufficiently distant by applying imperceptible perturbations, although distances can be devised that are robust to such perturbations.

In general, the “essence” or “style” of a dataset D is an abstract concept not included in the set of “protectable elements” of D, with models trained on it representing different embodiments, each comprising novel elements that are not in the specification of the dataset. These novel elements define the inductive bias needed to generate novel samples from the training data D. There are infinitely many possible embodiments of models trained using D, each of which can have different inductive behavior, each of which can generate different novel data.

For high dimensional data such as images, dataset emulation provides an approach to ensure that synthetic data is sufficiently different, which can be performed constructively by designing the learning criterion in such a way that it maximally differentiates synthesized samples from the original ones, or selectively by testing each synthesized sample and rejecting a sample deterministically if it fails the differentiation test.

Challenges remain in this approach, however, since synthetic data, even if realistic and indistinguishable from real to the human eye, may contain subtle artifacts that affect the performance of trained models. This is the analog of the “uncanny valley” of physics-based synthesis but transposed to an inductive learning setting. One of the key elements of dataset emulation is the choice of the criterion (distance or discriminant) that inductively defines the “style” or “spirit” of a particular dataset. Here, this choice may be delegated to the function y, left unspecified, since there is no canonical choice for it, and which choice is selected may depend on the specific application, dataset, or other factors. The choice of distance, as well as the margin, may be part of the dataset cards and factor into the conditions under which the data is used.

Turning to proactive disgorgement, given that even the tightest standards of data curation may be imperfect at the scale of the datasets in use in existing models, it may be worthwhile to train models in preparation for possible model disgorgement. That is, the models could be trained in such a way that model disgorgement may be later performed with minimal impact on the overall trained model. While the use of emulated datasets is one approach used by the systems and methods described herein, another approach used by the methods described herein is using emulated datasets in combination with proactive disgorgement. Proactive disgorgement may be used independently of emulated datasets in some instances as well.

One approach to proactive disgorgement involves splitting the dataset into multiple disjoint subsets (referred to as “shards”) and training separate models in isolation on each shard. Then, disgorging a sample only involves the sub-models trained on the subset containing the sample. Disgorgement requests may be addressed simply by eliminating or retraining the components of the model that have been exposed to the cohort of data in question.

These methods may be referred to as “compartmentalization,” as they separate information from different samples in different sub-models. The main design choices for compartmentalized models include how to split the training data, what architecture to use for the sub-models, and how to combine the sub-models. These in turn affect three aspects of the trained machine learning system: expected forgetting cost, model accuracy, and inference time latency.

Each time a disgorgement request is received, the sub-model corresponding to the shard that is being disgorged may need to be retrained, and the retraining time may be roughly proportional to the size of the shard. Hence, using smaller shards] (especially for samples that have a higher risk of being disgorged) leads to lower expected computational costs for each forgetting request. A “smaller” shard, for example, may refer to a shard that includes less than 1% of all of the training data that is used (however, this is not intended to be limiting). On the other hand, training sub-models on increasingly smaller shards results in progressively weaker models, thus reducing final accuracy. Moreover, splitting the data into small shards results in a larger total number of shards, with each associated with a sub-model that needs to be stored and executed at inference time, increasing the inference latency.

One compartmentalization method involves randomly splitting the data into uniform shards and training a separate copy of a standard network on each. Another approach starts with a network pre-trained on a core dataset deemed safe from disgorgement requirements and constructs a simple linear classifier on the data by computing the average embedding. This leads to lower accuracy than an unconstrained model but enables instant forgetting. To remove a sample, it is sufficient to subtract its embedding from the mean, without any retraining (thus the expected forgetting cost is close to zero). The second approach may involve better accuracy than the first approach when low forgetting cost is required. The first approach may also be applied to connectors learned on a pre-trained backbone.

A third approach improves over the first approach along all three axes: (a) it does not use uniform sharding, but rather optimizes the shard composition to improve the sub-models' performance, (b) uses a similar mechanism to the second approach to ensure accuracy for extremely low retraining time, and (c) uses training and running inference in parallel on thousands of shards with a significantly reduced computational cost. Another approach focuses on improving the ensembling procedure and selects and averages the top-k most relevant sub-models in an instance-dependent manner.

A further advantage of compartmentalization-based approaches is that the disgorgement of data of an entire shard (or multiple shards), as opposed to the disgorgement of individual samples, may be performed at essentially zero cost. Hence, it is expected that all samples from a data source may need to be disgorged at the same time, it may be beneficial to group all data from that source into a single shard, which may then easily be dropped. This, however, may be difficult to realize if the source does not exhibit sufficient variety to enable training strong sub-models. For example, if shards were organized by domain, each model built on a homogeneous shard may overfit to that domain, resulting in a collection of biased models.

Compartmentalization ensures that there is strictly zero influence on the disgorged data. Here, cost refers to not just the computational cost of retraining the affected sub-models, but also to the loss in accuracy due to architectural constraints and the nature of the shards, which may in some cases be so significant as to render the model ineffective. In the limit where the data to be disgorged is distributed across all shards, this method requires retraining from scratch.

In embodiments, described herein is the use of compartmentalized diffusion models (CDMs) for image generation. While using compartmentalization or mixture-of-experts has been conventionally employed for discriminative learning, compartmentalization is not conventionally used for generative learning with diffusion models. Combining different discriminative or even large language models (LLMs) is conventionally possible using techniques such as majority voting, or averaging due to the discrete nature of the output space. However, using these types of conventional approaches for image generation using diffusion models may be highly detrimental.

In contrast, the CDMs described herein combine the probability flows from different diffusion models at every step of diffusion to produce realistic images with better alignment compared to images produced using individual diffusion models.

Regarding the combination of probability flows, at every step in the reverse diffusion process, the probability flows in the optimal setting may combine in a linear way (for example, they are a linear combination of the individual flows). The coefficients of combination for the probability flows may depend on the probability that an intermediate noisy image was originally produced by one of the models. For example, there are two models (one model for identifying cats, and the other model for identifying dogs). Then at every intermediate step, which may include a noisy image, two determinations may be made, how likely is that this noisy image is a cat and how likely is that this noisy image is a dog. The sum of these two numbers should be equal to 1. Now at the start of the image may be very noisy, so the likelihood may be close to 0.5, 0.5 for each. However, as the inference progresses, the image is likely to be one of the two, as a result the likelihoods will change for instance, 0.9, 0.1. During the reverse diffusion, these coefficients (0.5, 0.5 or 0.9, 0.1) may be used to multiply with the probability flows.

In embodiments, it is possible to estimate these coefficients, however, this may not be practical given that the true distribution of the data may not be known. As a result, a classifier may be trained to estimate these probabilities for each time step. Given the noisy intermediate image, the classifier computes the likelihood that the intermediate noisy image belongs to one of the “N” categories (where N is the number of data splits or compartmentalized diffusion models), and uses the probabilities of the classifier model to multiply the individual probability flows. The classifier model can be trained on a subset of data, and is much smaller compared to the diffusion models. Training free classifier models like k-Nearest Neighbor based models to obtain probabilities to scale the flows may also be used.

CDMs enable efficient disgorgement, as the shards contaminated by the data sample that is no longer desired to be known may be re-trained, reducing the disgorgement time. Due to the compartmentalized nature of the models, CDMs also enable performing credit attribution (source/model attribution) for a generated image. More precisely, if CDMs are used for creating the emulated datasets, then the contribution of each model may be assessed (and thus the subset of data it was trained on) for each emulated image. Compartmentalization also aids in improving the model coverage due to its customizable nature, and helps reduce memorization.

Yet another emerging approach to provide for data protections in model training is retrieval augmented generation (RAG). RAG is a technique to adapt models to data without training, to handle credit attribution, and to allow efficient machine unlearning at scale. Rather than using user data to fine-tune the model, supporting samples are retrieved from it at inference time to guide the generation of new samples. Data may be easily added or removed from the retrieval data store without changes to the model, and users may access different subsets of the data based on their access-right. However, RAG methods are double edged, direct access to retrieved reference images often significantly improves the quality of generated samples, RAG models may copy information from the retrieved examples into the model output.

To remedy this, an improvement to RAG in the form of a copy-protected generation with retrieval (CPR) is described herein. CPR retrieves multiple private examples from the data pool. Information from all these samples is combined to generate a “private” diffusion flow which uses common information of those samples while discarding any unique and identifiable information. The resulting private flow is then optimally combined with the “public” flow generated by the base model to generate new outputs which still benefit from the retrieved samples, but minimize the risk of use of undesired information.

In particular, this improved approach satisfies the recently proposed notion of copyright protection using near access freeness (NAF), a relaxation of differential privacy aimed at protecting specific attribute of the training data. Differently from previously proposed methods like that realize NAF with a computationally expensive rejection sampling method, CPR does so by construction during the generation. Hence making our method significantly faster than the previous baselines and while also keeping inference cost deterministic.

Let p₀(x₀) be a data distribution over images, which is sought to model using a diffusion model. Score-based diffusion models define a (variance preserving) forward flow through a SDE, which transforms the distribution p₀(x₀) at time t=0 in a reference distribution p₁(x₁)=N(0, 1) at time t=1:

$${dx}_{t} = - \frac{1}{2} {β}_{t} {x}_{t} dt + \sqrt{{β}_{t}} d {ω}_{t} \qquad ( Equation 1 )$$

where xₜ is the diffused input at time t, dωₜ is a standard Wiener process, and βₜ are time varying coefficients (in practice implemented through linear or cosine scheduling), which determine the transition kernel and amount of noise added over time. The intermediate result pₜ(xₜ) of the diffusion process at time t equivalently expressed as the result of applying a Gaussian kernel pₜ(xₜ|x₀)= [symbol] (xₜ; yₜx₀,σₜ²I) to p₀(x₀), resulting in pₜ(xₜ)=∫ₓ_{₀}pₜ(xₜ|x₀)p₀(x₀)dx₀, where

$${γ}_{t} = exp ( - \frac{1}{2} \cdot {\int }_{0}^{t} {β}_{t} dt )$$

and σₜ²=1−γₜ².

The forward process in Equation 1 can be inverted through a corresponding backward process. In particular, this process can be used to generate samples of p₀(x₀) starting from a sample of p₁(x₁)=N(0, I):

$${dx}_{t} = ( - \frac{1}{2} {β}_{t} {x}_{t} - {∇}_{{x}_{t}} log {p}_{t} ( {x}_{t} ) ) dt + \sqrt{{β}_{t}} d {ω}_{t} \qquad ( Equation 2 )$$

where ∇ₓ_{ₜ} log pₜ(xₜ) is the score function of data distribution at t. Efficiently computing the score function is difficult. Instead, it can be approximated ∇ₓ_{ₜ} log pₜ(xₜ)≈s_{θ}(xₜ, t) using a deep network s_{θ}(xₜ, t), i.e., a diffusion model. In practice, diffusion models are often trained to take additional inputs s_{θ}(xₜ, t, c) in order to model a conditional distribution p₀(x₀|c), where the conditioning c provides additional information about the sample to generate, such as textual prompts. Given samples of the joint distribution p₀(x₀, c), a diffusion model s_{θ}(x, t, c) can be trained by minimizing the score-matching objective:

$${𝔼}_{( {x}_{0} , c ) ∼ {p}_{0} ( {x}_{0} , c )} {𝔼}_{t} [ ‖ {s}_{θ} ( {x}_{t} , t , c ) - {∇}_{{x}_{t}} log {p}_{t} ( {x}_{t} \vert {x}_{0} ) ‖ ] \qquad ( Equation 3 )$$

Directly generating samples using the backward flow modeled by s_{θ}(xₜ, t, c) can result into poor alignment. This can be improved through classifier-free guidance, which uses the modified score:

$${s}_{θ} ( {x}_{t} , t , ϕ ) + λ ( {s}_{θ} ( {x}_{t} , t , c ) - {s}_{θ} ( {x}_{t} , t , ∅ ) ) ,$$

where the hyper-parameter λ controls the guidance scale, and Ø denotes that no conditioning is fed to the model.

Below, a method for privacy-enabled RAG that is based on the notion of mixed-privacy is provided.

Let D={xⁱ, cⁱ}ᵢ₌₁^{N}˜p(x, c) be a “safe” training dataset, meaning that samples are considered public in the differential-privacy sense. It may be assumed that D is used to train a core public diffusion model s_{θ}(xₜ, t, c), that accepts c as conditioning information. It may also be assumed that c is the output of a CLIP encoder c=CLIP (<prompt>) fed with either a text prompt or an image prompt. Furthermore, let Dₚᵣᵢᵥₐₜₑ={xⁱ, cⁱ}ᵢ₌₁^{M} be a private dataset which may require frequent unlearning, or may require privacy or copyright protection. Dₚᵣᵢᵥₐₜₑ may be considered as the data store for retrieval.

At inference time, given a user prompt cₜₑₛₜ, a set of m relevant examples Dᵣₑₜᵣ={(xᵢ,ϕ(cᵢ, cₜₑₛₜ)}ᵢ₌₁^{m}⊂Dₚᵣᵢᵥₐₜₑ may be retrieved to aid the generation process. For simplicity, the closest m samples may be retrieved based on L₂-CLIP similarity score:

$$score = ‖ {c}_{test} - {c}_{i} ‖ + ‖ {c}_{test} - CLIP ( {x}_{i} ) ‖ .$$

Note however that in Dᵣₑₜᵣ the prompt of the retrieved samples may be modified through a function ϕ(cᵢ, cₜₑₛₜ)=cᵢ+cₜₑₛₜ in order to align them better with the user prompt.

Retrieved samples may be used to improve the generation of new samples. Formally, the goal of CPR is to modify the sampling backward process in order to generate samples from a weighted mixture of the distribution of D and Dᵣₑₜᵣ:

$$p ( x \vert c ) = {w}_{0} {p}_{D} ( x \vert c ) + {w}_{1} {p}_{{D}_{retr}} ( x \vert c ) \qquad ( Equation 4 )$$

where the weights w₀=λ and w₁=1−λ allow the user to control the contribution of the retrieved samples at inference time through an hyperparameter 0<λ<1.

To sample from this mixture distribution, its score function may be computed ∇ log pₜ(xₜ) at time t (see Equation 2).

$${p}_{t} ( {x}_{t} \vert c ) = \int {p}_{t} ( {x}_{t} \vert {x}_{0} ) [ {w}_{0} {p}_{D} ( {x}_{0} \vert c ) + {w}_{1} {p}_{{D}_{retr}} ( {x}_{0} \vert c ) ] {dx}_{0} \qquad ( Equation 5 )$$

where pₜ(xₜ|x₀)= [symbol] (xₜ; γₜx₀, σₜ²I) is a Gaussian kernel. The following two options provide expressions for the score of the mixture as a function of the score of the individual components.

As a first option, Let pₜ(xₜ|c) be as in Equation 5, then ∇ₓ_{ₜ} log pₜ(xₜ|c) is given by:

$${∇}_{{x}_{t}} log {p}_{t} = {\hat{w}}_{0}^{t} {∇}_{{x}_{t}} log {p}_{D}^{t} ( {x}_{t} \vert c ) + {\hat{w}}_{1}^{t} {∇}_{{x}_{t}} log {p}_{{D}_{retr}}^{t} ( {x}_{t} \vert c )$$

$$where :$$

$${\hat{w}}_{0}^{t} = {w}_{0} \frac{{p}_{D}^{t} ( {x}_{t} \vert c )}{{p}_{t} ( {x}_{t} \vert c )} , {\hat{w}}_{1}^{t} = {w}_{1} \frac{{p}_{{D}_{retr}}^{t} ( {x}_{t} \vert c )}{{p}_{t} ( {x}_{t} \vert c )}$$

and p_{D}^{t}(xₜ|c) denotes the forward flow of the distribution p_{D}(xₜ|c) at time t (and similarly for p_{D}_{ᵣₑₜᵣ}^{t}(xₜ|c)) and pₜ(xₜ|c)=p_{D}^{t}(xₜ|c)+p_{D}_{ᵣₑₜᵣ}^{t}(xₜ|c).

While ŵ₀^{t} and w₁^{t} could be computed exactly, treating them as fixed hyper-parameters may simplify the implementation. The scores ∇xₜ log p_{D}(xₜ|c) can be approximated empirically by a diffusion model s_{θ}_{₀}(x, t, c) trained on D. However, a model trained on the retrieved data Dᵣₑₜᵣ to estimate ∇ₓ_{ₜ} log p_{D}_{ᵣₑₜᵣ} (xₜ|c) may not exist. To solve the issue, recall that such a diffusion model s_{θ}_{₁} that minimizes the loss:

$${s}_{{θ}_{1}} = arg {min}_{{s}_{θ}} {E}_{( {x}_{0} , c ) ∼ {p}_{{D}_{retr}}} {𝔼}_{{x}_{t}} [ ‖ {s}_{θ} ( {x}_{t} , t , c ) - {∇}_{{x}_{t}} log ( \int {p}_{t} ( {x}_{t} \vert {x}_{0} ) {p}_{{D}_{retr}} ( {x}_{0} , c ) ) ‖ ] \qquad ( Equation 6 )$$

Since |Dᵣₑₜᵣ|<<|D|, the minimizer θ₁ may be expected to be a small small perturbation θ₁=θ₀+Δθ₁. However, finetuning s_{θ}_{₀}(x, t, c) to find such Δθ₁ for every inference request is computationally prohibitive.

Instead of fine-tuning, the expected behavior of s_{θ}_{₁} may be approximated through prompting. Textual inversion and prompt tuning have been shown to perform comparably to fine-tuning on small datasets while using orders of magnitude-less parameters. However, despite the reduction, it may still be still cumbersome to fine-tune at inference. Instead, the user prompt cₜₑₛₜ may be manually modified using the CLIP embeddings of the retrieved samples, and define the retrieval-score function:

$${\hat{s}}_{{θ}_{0}} ( {x}_{t} , t , {c}_{test} ) {=}^{Δ} {s}_{{θ}_{0}} ( {x}_{t} , t , \frac{1}{m} {\sum }_{{x}_{i} ∈ {D}_{retr}} CLIP ( {x}_{i} ) ) \qquad ( Equation 7 )$$

As a second option, assume that s_{θ} is Lipschitz in θ and c. Let s_{θ}_{₀}_{+Δθ}_{₁} (xₜ, t, c) be the optimal solution to Equation 6 and let Dᵣₑₜᵣ the private samples retrieved using cₜₑₛₜ. Then:

$$‖ {s}_{{θ}_{1}} ( {x}_{t} , t , c ) - {\hat{s}}_{{θ}_{0}} ( {x}_{t} , t , {c}_{test} ) ‖ \leq {l}_{θ} ‖ {Δθ}_{1} ‖ + {l}_{c} ‖ {c}_{test} - \frac{1}{m} {\sum }_{{x}_{i} ∈ {D}_{retr}} CLIP ( {x}_{i} ) ‖$$

This results guarantees that the optimal diffusion model trained on retrieved data may be approximated using the engineered prompt

$$\frac{1}{m} {\sum }_{{x}_{i} ∈ {D}_{retr}} CLIP ( {x}_{i} ) ,$$

which only requires computing the CLIP embeddings of the retrieved images. Combining the first option and the second option, an expression for the score function of retrieval-augmented mixture of distributions may be obtained, which may be referred to as the “retrieval-mixture-score”:

$${s}_{RAG} ( {x}_{t} , t , {c}_{test} ; {D}_{private} ) {=}^{Δ} {\hat{w}}_{0} {s}_{{θ}_{0}} ( {x}_{t} , t , {c}_{test} ) + {\hat{w}}_{1} {s}_{{θ}_{0}} ( {x}_{t} , t , ( 1 / m ) {\sum }_{{x}^{i} ∈ {D}_{retr}} CLIP ( {x}^{i} ) ) \qquad ( Equation 8 )$$

This method allows use any pre-trained CLIP-based diffusion model to generate retrieval augmented samples without any further changes. For example, this may be used to improve text-to-image alignment. At the same time, the retrieval-mixture score function already has immediate application to privacy, since it makes it trivial to unlearn examples contained in Dₚᵣᵢᵥₐₜₑ in constant time: these samples are not used to train any parameter, and hence may be forgotten by simply removing them from disk. However, samples retrieved at inference time can still leak private information.

To mitigate this, methods for copyright protected generation of samples using the mixed-privacy RAG method may be used.

Let Dₚᵣᵢᵥₐₜₑ be a set of private samples, whose information it is desired to protect, and let Δ be a divergence measure between probability distributions, such as the KL-divergence Δ_{KL} or thr max-divergence Δₘₐₓ (that is, the Renyi Divergence as α→∞). Let safe: Dₚᵣᵢᵥₐₜₑ→M be a function which maps a sample xⁱ∈Dₚᵣᵢᵥₐₜₑ to a generative model trained without using that xⁱ. The near access-free (NAF) criteria may be defined as follows. A generative model p(x|c) is k_{c}-near access-free (or k_{c}-NAF) on a prompt c with respect to Dₚᵣᵢᵥₐₜₑ, and Δ, safe, if for all xⁱ∈Dₚᵣᵢᵥₐₜₑ we have Δ(p(x|c)∥ safeₓi(x|c))≤k_{c}.

In practice, safe xⁱ may be a model trained with leave-one-out, or be sharded-safe, or simply be the safe core diffusion model s_{θ}_{₀} (xₜ, t, c). The above definition indicates that to perform safe generation the output sample must be close in distribution to a model which did not have access to the private samples in Dₚᵣᵢᵥₐₜₑ.

A first approach provides a simple procedure to generate NAF-protected samples with respect to KL-divergence. Given a dataset \tilde{D}, and copyrighted samples [symbol] ∈\tilde{D}, \tilde{D} may be split into two disjoint shards D₁, D₂, and train two generative models q⁽¹⁾, q⁽²⁾ on each respectively. Given the two models return a new model which satisfies k_{c}-NAF wrt Δ_{KL}

$$p ( x \vert c ) = \frac{\sqrt{{q}^{( 1 )} ( x \vert c ) {q}^{( 2 )} ( x \vert c )}}{Z ( c )}$$

where k_{c}=−2 log (1−H²(q⁽¹⁾(x|c), q⁽²⁾(x|c))), H is the Hellinger distance.

However, for diffusion models access to q⁽¹⁾ and q⁽²⁾ may not be available, but only to the scores ∇ₓ_{ₜ} log ∫qₜ(xₜ|x₀)q⁽¹⁾(x|c)dx₀ and ∇ₓ_{ₜ} log ∫qₜ(xₜ|x₀)q⁽²⁾(x|c)dx₀ respectively, where qₜ(xₜ|x₀) is a variance preserving Gaussian distribution. This approach may therefore be extended to generative models by extending the theorem to the scores of the models.

Given score functions, the approach may be provided in “Algorithm 1” shown below where the two scores may be averaged at every step during backward diffusion using Langevin Dynamics.

Algorithm 1: CPR-KL

| | Input: ∇ₓ_{ₜ} log ∫ qₜ (xₜ\|x₀)q⁽¹⁾(x\|c)dx₀, | | |
|---|---|---|---|
| | ∇ₓ_{ₜ} log ∫ qₜ (xₜ\|x₀)q⁽²⁾(x\|c)dx₀, T, N, cₜₑₛₜ | | |
| | Output: x₀ | | |
| 1 | x_{T} ~ [symbol] (0, I) | | |
| 2 | for t = T ... 0 do | | |
| 3 | \| | for i = 1 ... N do | |
| 4 | \| | \| | ${x}_{t} = {x}_{t} + \frac{{ϵ}_{t}}{2} .$ |
| | \| \| | \| └ | $\frac{1}{2} ( {∇}_{{x}_{t}} log \int {q}_{t} ( {x}_{t} \vert {x}_{0} ) {q}^{( 1 )} ( x \vert {c}_{test} ) {dx}_{0} + {∇}_{{x}_{t}} log \int {q}_{t} ( {x}_{t} \vert {x}_{0} ) {q}^{( 2 )} ( x \vert {c}_{test} ) {dx}_{0} ) ) + \sqrt{{ϵ}_{t}} z where z ∼ ( 0 , I )$ |

| | | |
|---|---|---|
| 5 | └ | xₜ₋₁ = xₜ |

Let x₀ be the output of Algorithm 1. In some instances, x₀ is k_{c}-NAF w.r.t. safe, [symbol] Δ_{KL}.

By the previous result, Algorithm 1 enables the generation of samples from Equation 9 as T, N increases and ∈ₜ decreases. However, in practice access to the optimal scores may not be available, but rather approximations which use DNNs may be used. In this example, having the safe model may be considered s_{θ}_{₀}(xₜ, t, c), and the RAG score on the private datastore s_{RAG}(xₜ, t, cₜₑₛₜ; Dₚᵣᵢᵥₐₜₑ). In practice, although combining the two scores as in Algorithm 1 can produce better results, it also doubles the computation cost at inference time.

To circumvent this, a second approach (Algorithm 2) is provided which approximates Algorithm 1 without increasing computational complexity may be used. This second approach does not incur the higher computational cost of the first approach. A method for estimating the probability of individual samples may involve computing the minimum mean square error (MMSE) using pre-trained text-to-image diffusion models. Let xₜ=γₜx₀+σₜ∈, x₀˜p(x₀|c) where ε˜ [symbol] (0, I), and

$$α ( t ) = log \frac{{γ}_{t}^{2}}{{σ}_{t}^{2}}$$

be the log SNR. Then the MMSE denoiser for a distribution p can defined as:

$$\tilde{s} ( {x}_{t} , t , c ; p ) {=}^{Δ} {argmin}_{s ( \cdot )} {𝔼}_{p ( {x}_{0} \vert c ) , ϵ} {‖ ϵ - s ( {x}_{t} , t , c ) ‖}^{2} = {𝔼}_{p ( {x}_{0} \vert {x}_{t} , c )} [ \frac{{x}_{t} - {γ}_{t} {x}_{0}}{{σ}_{t}} ] \qquad ( Equation 10 )$$

Using the MMSE de-noiser provides a simple expression for estimating the log probability of x₀.

$$log p ( {x}_{0} \vert c ) = - \int {𝔼}_{ϵ} {‖ ϵ - \tilde{s} ( {x}_{c} , t , c ; p ) ‖}^{2} {α}^{′} ( t ) dt + const \qquad ( Equation 11 )$$

Algorithm 2: CPR-Choose

| | Input: cₜₑₛₜ, \tilde{s}(xₜ, t, c; q⁽¹⁾), \tilde{s}(xₜ, t, c; q⁽²⁾), J, | | |
|---|---|---|---|
| | | | reverse-update(xₜ, sₜ) |
| | Output: x₀ | | |
| 1 | x_{T} ~ [symbol] (0, I) | | |
| 2 | for t = T ... , 0 do | | |
| | \| | | |
| 3 | \| | if t ∈ J then | |
| | \| | \| | |
| 4 | \| | \| | s(xₜ, t, cₜₑₛₜ) = \tilde{s}(xₜ, t, cₜₑₛₜ; q⁽²⁾) |
| | \| | \|_{—} | |
| 5 | \| | else if t ∉ J then | |
| | \| | \| | |
| 6 | \| | \| | s(xₜ t, cₜₑₛₜ) = \tilde{s}(xₜ, t, cₜₑₛₜ; q⁽¹⁾) |

| | | |
|---|---|---|
| | \| | \|_{—} |
| 7 | \| | xₜ−1 = reverse-update(xₜ, s(xₜ, t, cₜₑₛₜ)) |

|_{—}

where α′(t) is the time-derivative of α(t). Note that \tilde{s}(xₜ, t, c; p) is also equivalent to the diffusion score obtained previously.

This result shows that to obtain NAF w.r.t. Δₘₐₓ=log p(x|c)/safe(x|c), all that may be required is to bound the difference in MMSE at each time step t. This bounding may be performed by choosing p(x|c)=safe(x|c) for majority of t, while using Dₚᵣᵢᵥₐₜₑ intermittently for remaining t.

Using these results, another algorithm may be provided for copy-protected generation. Let q⁽¹⁾, q⁽²⁾ be the models obtained using D₁, D₂ respectively. It may be assumed that the total data is sharded in such a way that D₁ contains the safe data, while D₂ contains the copy-protected data. Let q⁽¹⁾ be our safe-model. In practice, access may be provided to the score function or the MMSE denoiser, \tilde{s}(xₜ, t, c; q⁽¹⁾), \tilde{s}(xₜ, t, c; q⁽²⁾).

NAF Δₘₐₓ algorithm Let J={[tᵢ, tᵢ₊₁]|tᵢ₊₁≤tᵢ₊₂, i∈{0, 2, 4, . . . , N}, t₀≥0, t_{N+1}<∞, N<∞} be a subset of disjoint time-intervals on the real line. Using the set J, a new distribution may be defined as:

$$\tilde{q} ( {x}_{0} \vert c , t ) = {q}^{( 1 )} ( {x}_{0} \vert c ) + {q}^{( 2 )} ( {x}_{0} \vert c ) \qquad ( Equation 12 )$$

This new distribution is a time-dependent, which essentially selects a distribution at time t to sample xₜ. The benefit of such an approach is that it enables the user to select one of the two model during backward diffusion at each timestep.

Let \tilde{s}(xₜ, t, c; \tilde{q}) be the MMSE denoiser for Eq. (12), then it may be shown that:

$$\tilde{s} ( {x}_{t} , t , c ; \tilde{q} ) = \tilde{s} ( {x}_{t} , t , c ; {q}^{( 1 )} ) + \tilde{s} ( {x}_{t} , t , c ; {q}^{( 2 )} ) \qquad ( Equation 13 )$$

This result states the fact that optimal MMSE de-noiser for Equation 12 may choose one of the two de-noisers depending on the time-step, where the choice of J can be completely user dependent.

Let x₀ be the output of Algorithm 2. Under certain regularity conditions (see Supplementary Material), x₀ is k_{c}-NAF w.r.t. safe, [symbol] , Δₘₐₓ.

Often in practice the diffusion process may be modeled using a discrete markov chain. For discrete markov chains discrete in t the output of models may be denoted q⁽¹⁾ (safe-model), q⁽²⁾ using the entire trajectory, {x₀, . . . , x_{T}}). The set of intervals J becomes a set of discrete time-steps. During backward diffusion, at each t the user can use one of the two models to generate the score for updating xₜ. Depending on the choice of J, completely safe images (J to be empty) may be generated. This leads to two CPR-Choose algorithms, depending on the choice of J.

In one setting, J may be selected such that at each t, the model with the larger MSE is selected, which can be considered as choosing the worst model at each t. This may generate samples from a distribution which approximates the minimum of the two distributions. This in intuitive because, for time-stamps when q⁽¹⁾ (which is the safe model) is chosen, no loss is incurred for Δₘₐₓ, and it is only for the remaining terms that Amax may need to be bounded.

Similarly, J may be chosen to alternate between the two models by choosing q⁽²⁾ (private model) at regular intervals, like e.g. every \tilde{t} steps, or in the most simplest case, in an alternating fashion. Using this approach, it may only be necessary to compute the Δₘₐₓ at every \tilde{t} steps to bound k_{c}.

In experiments, q⁽¹⁾ may be the s_{θ}_{₀}(xₜ, t, c) which is trained on the safe-core data, while q⁽²⁾ be the s_{RAG}(xₜ, t, c; Dₚᵣᵢᵥₐₜₑ) which uses the private data at inference using retrieval.

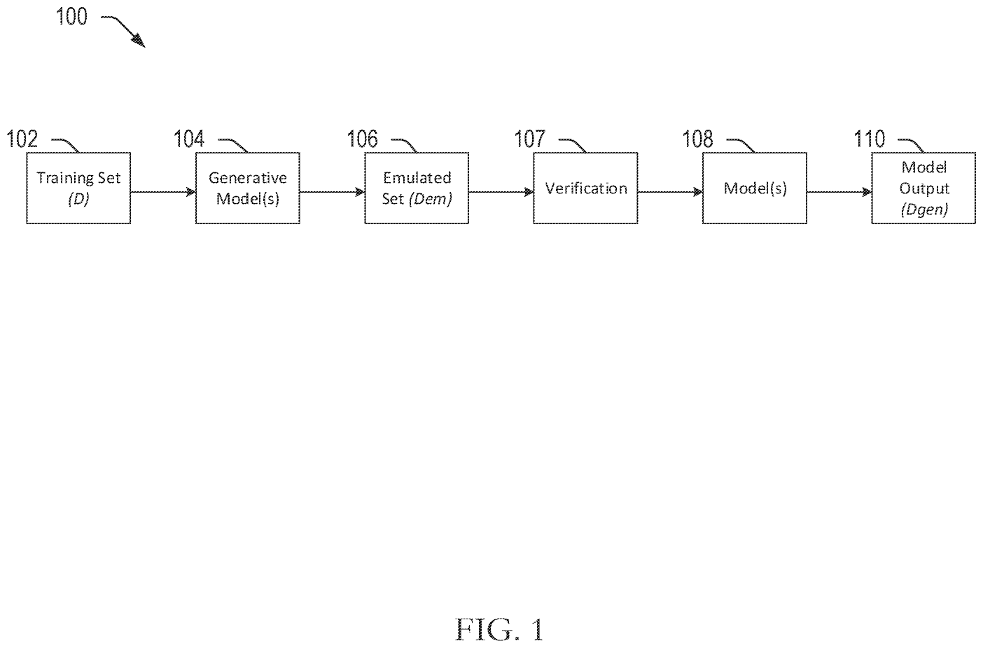

Turning to the figures, FIG. 1 depicts a flow diagram 100 for training a machine learning model using an emulated dataset 106. The flow diagram 100 begins with an initial training dataset 102 (which may be referred to as “D” herein). For consistency sake, reference may be made herein to training datasets including images, however, any other type of training data may also be used as well, such as text-based training data, etc.

Certain portions of the initial training dataset 102 may be undesirable to be known by the machine learning model 108 (the model that is used to perform downstream tasks after the machine learning model 108 has been trained). For example, some of the initial training dataset 102 may include personally-identifiable information, such as biometric information in the form of images of faces of individuals. As another example, if the model is a diffusion model that produces output images based on text prompts, the undesirable information may include copyrighted works of artists. These are merely exemplary and any other types of information may also be undesired to be used by the final machine learning model 108 for any number of reasons. As another example, the training data may be text-based information and may include trade secrets desired by a corporation to remain trade secrets. In some instances, it may be initially undesirable for such information to be used to train the final machine learning model 108. In other instances, it may be determined after the machine learning model 108 has been trained that it is no longer desired for the machine learning model 108 to have knowledge of such information. The determination as to whether data is undesirable to be known by the machine learning model 108 may be performed automatically by a system or device, however, in some cases, a user may provide a manual indication that is undesired for data to be known by the machine learning model 108.

Regardless, model disgorgement may be used to ensure that undesirable data is not known by the machine learning model 108. As one aforementioned approach to this disgorgement, rather than using the initial training dataset 102 to train the machine learning model 108, an emulated dataset 106 (which may be referred to as “Dₑₘ” herein) is generated that may instead be used to train the machine learning model 108. This emulated dataset 106 may include at least some model-generated data that is based on the initial training dataset 102, but does not include the undesirable portions of the initial training dataset 102.

To produce the emulated dataset 106, the initial training dataset 102 may be provided to a first generative model 104. The first generative model 104 may be trained using the initial training dataset 102, such that the first generative model 104 has knowledge of the information included in the initial training dataset 102. Once trained, the generative model 104 may then be used to generate the emulated dataset 106, which may be a different dataset that is based on the initial training dataset 102. By the nature of the emulated dataset 106 being a newly-generated dataset, the undesirable portions of the initial training dataset 102 may inherently be removed from the emulated dataset 106.

A generative model is a type of machine learning model that focuses on understanding how the input data is generated and aims to learn the distribution of the data itself. For instance, if the input data includes images of cars, the generative model attempts to understand what makes a car look like a car. The generative model may then be able to generate new images that resemble cars. Non-limiting examples of different types of generative models may include Baysean networks, diffusion models, generative adversarial networks (GANs), variation encoders (VAEs), restricted Boltzmann machines (RBMs), pixel recurrent neural networks (PixelRNNs), Markov chains, normalizing flows, etc.

Another approach to generating the emulated dataset 106 involves generating a natural language description of the data included in the initial training dataset 102. The generative model 104 may then be used to generate the emulated dataset 106 using the natural language description rather than using the initial training dataset 102 itself. This provides a further level of separation between the emulated dataset 106 and the initial training dataset 102. The natural language description may be generated in any suitable manner. For example, the natural language description may also be generated by a model, may be manually provided by a user, etc.

In embodiments, an optional verification step 107 may be performed to ensure that the emulated dataset 106 is sufficiently different from the initial training dataset 102. That is, the emulated dataset 106 may be analyzed to determine if the distance between the emulated dataset 106 and the initial training dataset 102 meets one or more pre-defined threshold(s).

To train a model based on a dataset, the data in the dataset may need to be transformed or encoded into numbers such that the dataset is in a format that is readable by the model. Vectors, and matrices represent inputs such as text and images (or other types of inputs) as numbers, so that the data may then be used to train the model. Thus, the difference between these numerical values may be used to determine the separation between the emulated dataset 106 and the initial training dataset 102. The distance value(s) may then be compared pre-determined threshold(s) to determine if the difference between the emulated dataset 106 and the initial training dataset 102 is sufficient (e.g., satisfies the thresholds). As used herein, “satisfying” a threshold value may differ depending on the type of threshold used. For example, satisfying the threshold may include the distance being greater than, greater than or equal to, less than, less than or equal to the threshold value(s).

In some instances, the difference between the initial dataset 102 and the emulated dataset 106 may also be determined in any other suitable manner. For example, it may be desirable to remove copyrightable elements of a dataset, and thus determining the difference between the initial training dataset 102 and the emulated dataset 106 may involve determining if the “essence” or “style” of the datasets differ by a sufficient amount. This optional verification may be manually performed by a user or may be automatically performed by the system. The one or more threshold(s) may also be manually established by the user or may be automatically determined by the system.

Once the emulated dataset 106 is generated by the first generative model 104 (and the optional verification step is performed, if applicable), the emulated dataset 106 may be used to train the machine learning model 108. Once trained, the machine learning model 108 may then be used to perform downstream tasks (for example, producing outputs 110 (which may be referred to as “D_{gen}” herein)). For example, if the initial training dataset 102 includes images of people, the machine learning model 108 may be used to identify whether people exist in input images that are provided to the machine learning model 108. This is merely one example of a type of task that a model may be trained to perform. As further non-limiting examples, the machine learning model 108 may be trained to perform computer vision tasks, natural language processing tasks, and/or any other types of tasks. The benefit provided is that the machine learning model 108 is trained to perform this task without having visibility to undesirable portions of the initial training dataset 102.

While the use of the emulated dataset 106 as shown in the flow diagram 100 is one approach to disgorgement, another approach, compartmentalization, may also be used either in combination with the emulated dataset or individually without the use of the emulated dataset 106. Any reference to only the use of emulated data herein may not be intended to be limiting and compartmentalization may also (or alternatively) be applicable as well.

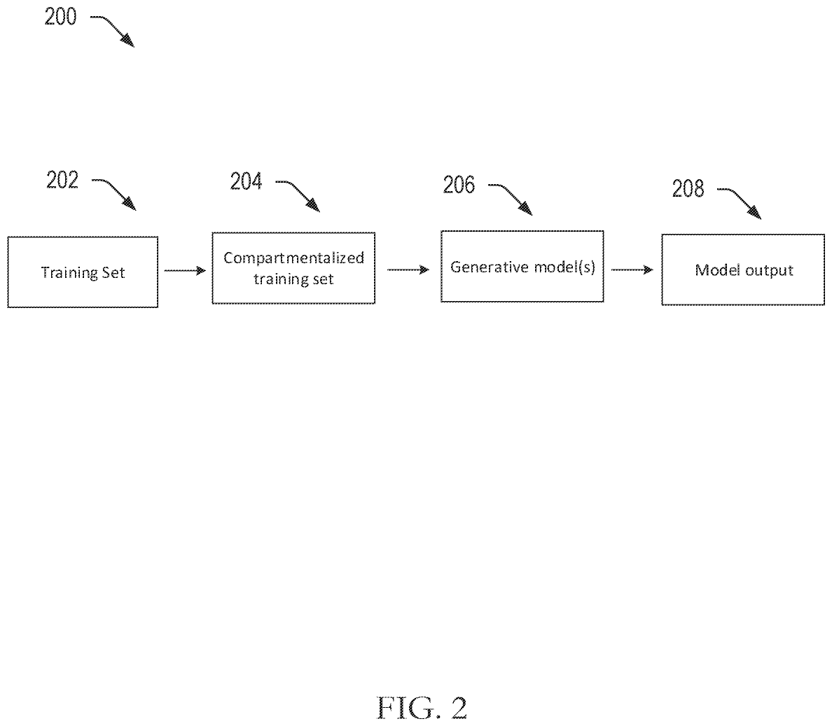

FIG. 2 depicts another flow diagram 200 in which a compartmentalization approach is taken as an alternative to the generation and use of an emulated dataset to train the generative model 206 (however, compartmentalization and the use of the emulated dataset may also be performed in combination as well). Training models in a compartmentalized manner may enable compositional inference while preserving image quality and alignment, enabling efficient unlearning, credit attribution, improving out-of-distribution coverage, and reducing memorization (enabling emulation). As one example, the approach described herein may produce compartmentalized diffusion models, however, may also be applicable to any other type of generative model or any other type of machine learning model in general (any reference to a “diffusion model” hereinafter may be interchangeable with any other type of model).

Some existing methods provided methods for compositional image generation, however their method is aimed at improving the text-to-image alignment during generation. At inference, they propose to break the input prompt into subparts, compute the de-noising prediction for each, and then average at each step during backward diffusion. While our method is aimed at improving the privacy of the model by sharding the training dataset into multiple subsets and training separate model for each. The two approach are completely orthogonal, as one involves breaking the inference prompt into nouns and using the same model multiple times, while ours involves splitting the training set and training separate models.

Generally, the flow diagram 200 may involve receiving a training dataset 202, splitting the training dataset 202 into multiple disjoint subsets (referred to as “shards”) to form the compartmentalized training dataset 204, and training separate model(s) 206 in isolation on each shard. Then, disgorging a sample only involves the sub-models trained on the subset containing the sample. The separate model(s) 206 are used in conjunction to produce a model output 208.

In producing compartmentalized models, separate parameters or prompts may be trained independently using different data sources, ensuring (deterministic) isolation of the respective information. At inference time, all parameters may then be merged and used jointly to generate samples. This technique is simple to implement with any existing model architecture and allows for both selective forgetting and continual learning to be performed on large-scale diffusion models (or other types of models).

In addition to enabling the removal of information in the trained model from particular data, the method also allows attribution, which may inform the process of assessing the value of different cohorts of training data, as well as ensure that there is no memorization so the generated images are not substantially similar to those used for training.

The key enabler of compartmentalized models is a closed-form expression for the reverse diffusion flow of a mixture distribution in terms of the flows of its components. This expression may be implemented with existing models, but may be associated with two challenges. First, training and running separate models or adapters on different subsets of the data may quickly increase the storage and inference costs of the model. Second, assembling independent models and/or adapters trained on different subsets of the data may, in principle, significantly underperform a single model trained on all the data together, due to loss of synergistic information between samples.

To address the first challenge, a pre-trained diffusion model may be used and fine-tuned on various downstream datasets. Fine-tuning the model assists the model in preserving the synergistic information across different shards. Further, the single shared backbone may be kept fixed and adapters or prompts may be trained on each disjoint shard of data. The prompts may be forwarded in parallel, taking advantage of efficient batch-parallelization for quick inference. Adapters can be trained remotely and shared with a central server without the need to share the raw data.

Regarding the second challenge, the compartmentalized model may match the generative performance of a paragon model trained on all the data jointly (in some cases outperform a jointly trained model due to regularization), while also providing for all the aforementioned data security improvements. This is both due to the particular objective of diffusion models, which in theory allows separate model training without any loss in performance (even if this need not be the case for real models), and to the use of a safe training set, which allows the compartmentalized model components to still capture a significant amount of synergistic information.

Consider a dataset D={D₁, . . . , Dₙ} composed of “n” of different data sources Dₙ. The core idea of compartmentalized models is to train separate models or adapters independently on each Dᵢ, and compose them to obtain a model that behaves similarly to a model trained on the union∪Dᵢ of all data. The score based stochastic differential equation formulation of diffusion models may be used.

Let p(xₒ) be the (unknown) ground-truth data distribution that is sought to be modeled. At any time t in the forward process, the conditional distribution of the input may be defined as:

$${dx}_{t} = - \frac{1}{2} {β}_{t} {x}_{t} dt + \sqrt{{β}_{t} d {ω}_{t}} \qquad ( Equation 14 )$$

Here, xₜ is the input at time “t” in the forward process, βₜ are the transition kernel coefficients and dωₜ is the standard Wiener process. There exists a backward process, which allows for the generation of samples from p(xₒ) given a random sample x_{T}˜ [symbol] (0,1). This is given by the backward diffusion equation:

$${dx}_{t} = ( - \frac{1}{2} {β}_{t} {x}_{t} - {∇}_{{x}_{t}} log {p}_{t} ( {x}_{t} ) ) dt + \sqrt{{β}_{t}} d {ω}_{t} \qquad ( Equation 15 )$$

where pₜ(xₜ)=∫ₓ_{₀}pₜ(xₜ|x₀)p₀(x₀)dx₀ is the marginal distribution at time t. This previous result indicates that only access to ∇ₓ_{ₜ} log pₜ(xₜ) is needed to generate samples from p(x₀), which is independent of any normalization constant. There also exists an ordinary differential equation corresponding to Equation 15 which enables quicker generation samples from p(x₀). In practice, pₜ(xₜ)=∫ₓ_{₀}pₜ(xₜ|x₀)p₀(x₀)dx₀ may be modeled using a deep neural network s_{θ}(xₜ, t) (or ε_{θ}(xₜ, t), and optimizing using score matching.

Turning to compartmentalized diffusion models, the case is considered where the data distribution p(x₀) is composed as a mixture of distributions:

$$p ( {x}_{0} ) = {λ}_{1} {p}^{( 1 )} ( {x}_{0} ) + … + {λ}_{n} {p}^{( n )} ( {x}_{0} ) \qquad ( Equation 16 )$$

such that the data from each training source Dᵢ is sampled from its corresponding mixture component p⁽ⁱ⁾(x). Suppose that n independent diffusion models have been trained on each p⁽ⁱ⁾(x) independently, leading to n different score functions {∇ₓ_{ₜ} log p⁽ⁱ⁾(xₜ)}ᵢ₌₁ⁿ (empirically {s_{θ}⁽ⁱ⁾(xₜ, t)}ᵢ₌₁ⁿ). The question is whether these mixture-specific score functions may be combined to generate a sample from the global distribution p⁽ⁱ⁾(x). To this end, the score function of the global distribution may be found and written using the score function of the individual distributions. Then, using the trained models s_{θ}⁽ⁱ⁾(xₜ, t) the empirical score for the global distribution may be approximated and diffusion samplers may be used to obtain samples.

To compute the score for the global distribution, the global marginal distribution may need to be computed. Using the linearity of integration with a Gaussian it may be shown that:

$$( Equation 17 )$$

$${p}_{t} ( {x}_{t} ) = \int {p}_{t} ( {x}_{t} \vert {x}_{0} ) {\sum }_{i = 1}^{n} {λ}_{i} {p}^{( i )} ( {x}_{0} ) = {\sum }_{i = 1}^{n} {λ}_{i} {p}_{t} ( {x}_{t} \vert {x}_{0} ) {p}^{( i )} ( {x}_{0} ) = {\sum }_{i = 1}^{n} {λ}_{i} {p}_{t}^{( i )} ( {x}_{t} )$$

To sample from the global distribution Equation 16 using Equation 15, the score of the marginal Equation 17 may need to be computed.

Let {s_{θ}⁽ⁱ⁾(xₜ, t)} be a set of diffusion models trained on {Dᵢ}ᵢ₌₁ⁿ separately. Then the score function corresponding to a diffusion model trained on {Dᵢ}ᵢ₌₁ⁿ jointly is given by,

$${s}_{θ} ( {x}_{t} , t ) = {\sum }_{i = 1}^{n} {w}_{t} ( {x}_{t} , t ) {s}_{θ}^{( i )} ( {x}_{t} , t ) \qquad ( Equation 18 )$$

$$where {w}_{t} ( {x}_{t} , t ) = {λ}_{i} \frac{{p}_{t}^{( i )} ( {x}_{t} )}{{p}_{t} ( {x}_{t} )} , {p}_{t} ( {x}_{t} ) = {\sum }_{i = 1}^{n} {λ}_{i} {p}_{t}^{( i )} ( {x}_{t} )$$

### Proof.

$$\begin{matrix}{∇}_{{x}_{t}} log {p}_{t} ( {x}_{t} ) = {∇}_{{x}_{f}} log ( {\sum }_{i =}^{n} 1 {λ}_{i} {p}_{t}^{( i )} ( {x}_{t} ) ) \\ = \frac{1}{{\sum }_{i = 1}^{n} {λ}_{i} {p}_{t}^{( i )} ( {x}_{t} )} {\sum }_{i = 1}^{n} {λ}_{i} {∇}_{{x}_{t}} {p}_{t}^{( i )} ( {x}_{t} ) \\ = \frac{1}{{p}_{t} ( {x}_{t} )} {\sum }_{i = 1}^{n} {λ}_{i} {∇}_{{x}_{t}} {p}_{t}^{( i )} ( {x}_{t} ) \frac{{p}_{t}^{( i )} ( {x}_{t} )}{{p}_{t}^{( i )} ( {x}_{t} )} \\ = {\sum }_{i = 1}^{n} {λ}_{i} \frac{{p}_{t}^{( i )} ( {x}_{t} )}{{p}_{t} ( {x}_{t} )} {∇}_{{x}_{t}} log {p}_{t}^{( i )} ( {x}_{t} )\end{matrix} \qquad ( Equation 19 )$$

where it may be assumed that each deep neural network has enough capacity to minimize [symbol] ₓ_{₀}_{,t}∥∇ₓ_{ₜ} log pₜ⁽ⁱ⁾(xₜ)−s_{θ}⁽ⁱ⁾(xₜ, t)∥². Thus, ∇ₓ_{ₜ} log pₜ⁽ⁱ⁾(xₜ) may be replaced with its empirical estimate s_{θ}⁽ⁱ⁾(xₜ, t).

This additional term has an intuitive interpretation. Let x₀˜p(x)=Σᵢλᵢp⁽ⁱ⁾(x) be a sample from the mixture distribution, and let z∈{1, . . . , n} be a discrete random variable which tells us the index of the mixture component that generated the sample (so that p(x|z=i)=p⁽ⁱ⁾(x) and p(x)=Σᵢp(x|z=i)p(z=i). Then, by Bayes's rule, one readily sees that

$${p}_{t} ( z = i \vert x ) = \frac{{p}_{t}^{( i )} ( x )}{{p}_{t} ( x )} .$$

That is, the additional weighting factor for each model may be interpreted as the probability that the current noisy sample xₜ originated from the data distribution used to train that model. To illustrate the behavior, consider the case where p⁽¹⁾(x) and p⁽²⁾(x) are disjoint (for example, images of pets and flowers respectively). At the beginning of the reverse diffusion, due to the amount of noise the sample is equally likely to be generated from either distribution, both may have similar weight. As the time increases and more details are added to the sample, the image may increasingly be more likely to be either a pet or a flower. Correspondingly, the generated image should draw only from the relevant domains, whereas using others may force the model to generate images of flowers by inductively combining images of pets.

This interpretation also provides a way to compute

$$\frac{{p}_{t}^{( i )} ( x )}{{p}_{t} ( x )} .$$

In principle, one could estimate both pₜ^{(x)} and pₜ(x) using the diffusion model itself, however this is computationally expensive. On the other hand, pₜ(z=i|x) is simple to estimate directly with a small auxiliary model. Let f(x, t) be a n-way classifier that takes as input a noisy image x and a time-step t and outputs a softmax. To train an example neural network, pairs {(xᵢ, kᵢ)}ᵢ₌₁^{N} may be generated, where kᵢ˜1, . . . , n is a random component index and xᵢ˜N(x|γₜx₀, σₜ²I), x₀˜Dₖ_{ᵢ} is obtained by sampling a training image from the corresponding dataset Dₖ_{ᵢ} and adding noise to it. The network is trained with the cross-entropy loss to predict kᵢ given xᵢ and t. Then, at convergence

$$f ( x , t ) = ( \frac{{p}_{t}^{( 1 )} ( x )}{{p}_{t} ( x )} , … , \frac{{p}_{t}^{( n )} ( x )}{{p}_{t} ( x )} ) .$$

Let f_{w} be a classifier trained as described. Then f_{w}(x, t)ᵢ=wᵢ(xₜ, t) where wᵢ(xₜ, t) is as in Equation 5.

The classifier helps implement model selection at inference time, which aims to select the best model which describes the data distribution. However, when all the components of the mixture distribution are close in a distributional sense, the classifier may be replaced with naive averaging of the ensemble of diffusion scores. In practice, using all the models at each time-step of backward diffusion can be computationally expensive, in such situations, the averaging of scores may be approximated with simple random score selection. Thus, there may be three methods for assembling the diffusion scores at inference, (1) classifier, (2) naive averaging, and (3) random selection.

The compartmentalized models may be used in a number of applications, such as text-to-image alignment, forgetting, continual learning, measuring contributions of individual scores, better out-of-domain 9OOD) coverage and reduced memorization, etc.

With respect to forgetting, owners of the training data may, at any point, modify their sharing preferences leading to a shrinking set “S” of usable data sources. When this happens, all information about that data needs to be removed from the model. However, the large amount of current state-of-the-art diffusion models precludes re-training on the remaining data as a viable strategy. Compartmentalized models such as CDMs allow for a simple solution to the problem: if a data source D_i is removed, only the corresponding model f_i needs to be removed to remove all information about it. Moreover, if only a subset of a training source is removed, it is only necessary to retrain the corresponding model.

With respect to continual learning, the data sources D_i may represent additional batches of training data that are acquired incrementally. Retraining the model from scratch every time new data is acquired, or fine-tuning an existing model, which brings the risk of catastrophic forgetting, is not desirable in this case. With CDMs, one can simply train an additional model f_i on D_i and compose it with the previous models.

With respect to measuring contribution of individual sources, let x_0 be a sample generated solving the Equation 15 starting from an initial x_1˜p_1 (x). The likelihood of a generated image can then be computed as

$$log {p}_{1} ( {x}_{1} ) - log p ( {x}_{0} ) = - {\int }_{0}^{1} div {∇}_{{x}_{t}} log {p}^{( i )} ( {x}_{t} ) dt$$

that is, the divergence of the score function integrated along the path. In the case of a CDM, this likelihood can further be decomposed as:

$$log {p}_{1} ( {x}_{1} ) - log {p}_{0} ( {x}_{0} ) = {\sum }_{i} {λ}_{i} \int div ( {w}_{i} ( {x}_{t} , t ) {∇}_{{x}_{t}} log {p}^{( i )} ( {x}_{t} ) ) dt = {\sum }_{i} {λ}_{i} {L}_{i}$$

where Lᵢ can be interpreted as the contribution to each component of the model to the total likelihood. Using this, the credit Cᵢ of the data source Dᵢ may be quantified as:

$${C}_{i} = \frac{λ {L}_{i}}{{\sum }_{j = 1}^{n} {λ}_{j} {L}_{j}}$$

While ΣᵢλᵢLᵢ is the likelihood assigned by the CDM to the the generated sample, one cannot interpret the individual Lᵢ as the likelihood assigned by each submodel. When shards belongs to different distributions the credit attribution is correctly more skewed (generated image belongs to one distribution) compared to similar distributions which has a more uniform attribution (since all distributions are similar).

With respect to memorization, compartmentalized diffusion models can reduce memorization in diffusion models by ensembling diffusion paths from different models at inference, as a result the generated image may not resemble output from any particular source model. Compartmentalized diffusion models help improve the diversity of the synthesized images along with reduced memorization.

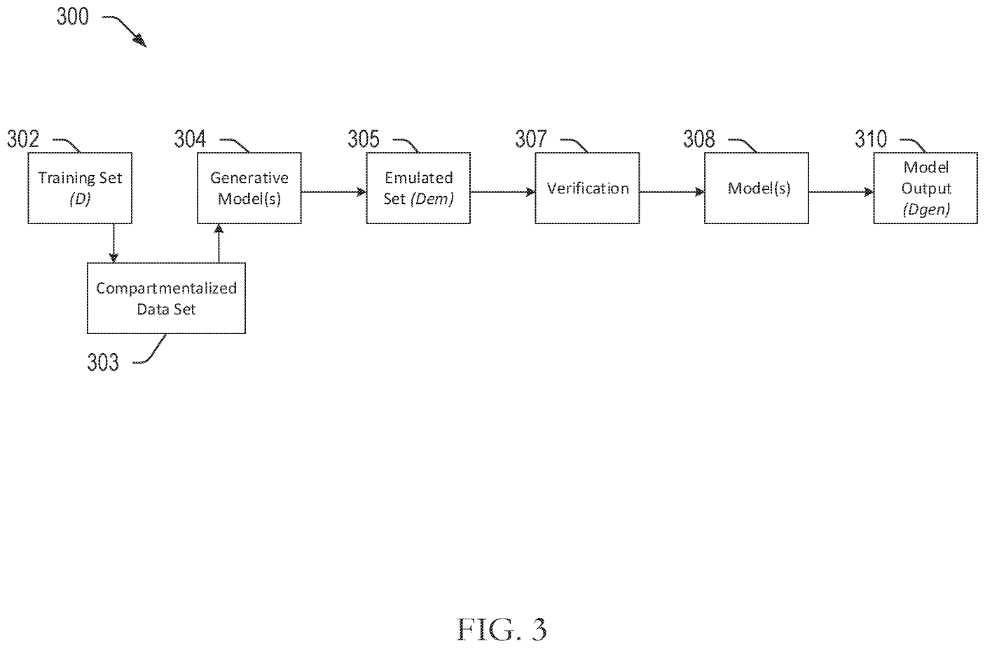

FIG. 3 depicts another flow diagram 300 in which compartmentalization is used in combination with an emulated training dataset to train the machine learning model 308. The use of the data compartmentalization and the emulated training dataset provides a further layer of model disgorgement to ensure that the machine learning model 308 does not have visibility on some or all of the initial training dataset 302.

The flow diagram 300 includes similar steps as the flow diagram 100. For example, the flow diagram 300 begins with an initial training dataset 302. To produce the emulated dataset 306, the initial training dataset 302 may be provided to a first generative model 304. The first generative model 304 may be trained using the initial training dataset 302, such that the first generative model 304 has knowledge of the information included in the initial training dataset 302. Once trained, the generative model 304 may then be used to generate the emulated dataset 306, which may be a different dataset that is based on the initial training dataset 302. Alternatively, a natural language description may be used by the generative model to generate the emulated dataset 306, as described herein. Once the emulated dataset 306 is generated by the first generative model 304 (and the optional verification step is performed, if applicable), the emulated dataset 306 may be used to train the machine learning model 308. Once trained, the machine learning model 308 may then be used to perform downstream tasks (for example, producing outputs 310). Additionally, an optional verification step 307 may be performed to ensure that the emulated dataset 306 is sufficiently different from the initial training dataset 302.

The flow diagram 300 differs from flow diagram 100 in that a compartmentalized training dataset 303 is generated. The compartmentalized training dataset 303 may be generated in any manner described herein or otherwise (such as a manner described with respect to the flow diagram 200, for example). Although the flow diagram 300 shows that compartmentalization is performed on the initial training dataset 302, this is not intended to be limiting. The compartmentalization may also be performed at another stage in the flow diagram 300 as well. The flow diagram 300 may also differ from the flow diagram 100 in that multiple trained machine learning models 308 may result from the compartmentalization that may produce the model output 310 in combination.

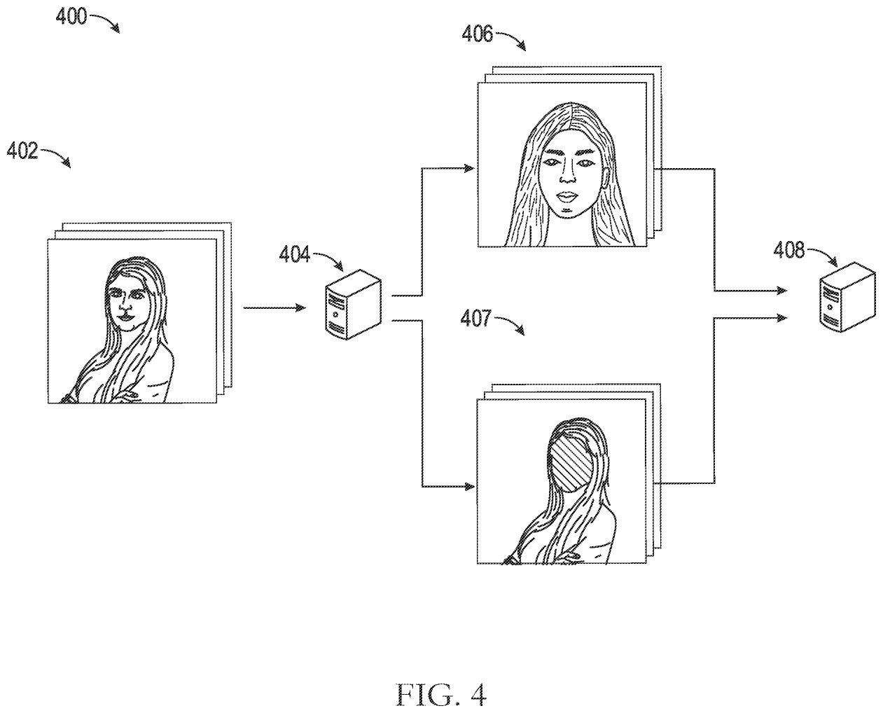

FIG. 4 depicts an example use case 400 in which the emulated data is used to protect biometric information found in images of people in an initial training dataset. In the use case 400, the initial training dataset includes a first set of images 402. However, at least one of the images included in the initial training dataset shows the face of a person. It may be undesirable for this personally-identifiable information to be used to train the final machine learning model 408 that is used to perform downstream tasks.

To allow the final machine learning model 408 to be trained without the use of the personally-identifiable information, the first set of images 402 may first be provided to a generative model 404. Based on the first set of images 402, the generative model 404 may generate an emulated dataset that does not include the personally-identifiable information. FIG. 4 shows two example alternatives for the emulated dataset. A first example of the emulated dataset includes a second set of images 406 in which the original facial features of the person shown in the first set of images 402 are replaced with different facial features such that the person in the first set of images 402 is no longer identifiable. A second example of the emulated dataset includes a third set of images 407 in which the facial features of the person shown in the first set of images 402 are blurred.

The emulated dataset (for example, the second set of images 406 or the third set of images 407) may be used to train the final machine learning model 408 rather than the first set of images 402. In this manner, the final machine learning model 408 may still be trained to perform the task of identifying a person within an image, but may not be trained with the image including the facial features of the person shown in the first set of images 402.

The use case 400 also illustrates that the emulated dataset may include some portions that are similar to, or the same as, the initial training dataset. That is, the emulated dataset may not necessarily involve alerting all of the data in the initial training dataset. For example, rather than the second set of images 406 and the third set of images 407 presenting completely different information, only the information that is undesired to be used to train the final machine learning model 408 is removed in the emulated dataset.

This partial modification of the initial training dataset may be performed in any suitable manner. As one option, only the portion of the initial training dataset that is desired to be removed may be provided to the generative training model. As another option, all of the initial training dataset may be provided to the generative model and the generative model may selectively identify the portions of the initial training dataset for which emulated data may need to be generated. A user may also manually indicate which portions of the initial training dataset are desired to be removed through the generation of the emulated dataset.

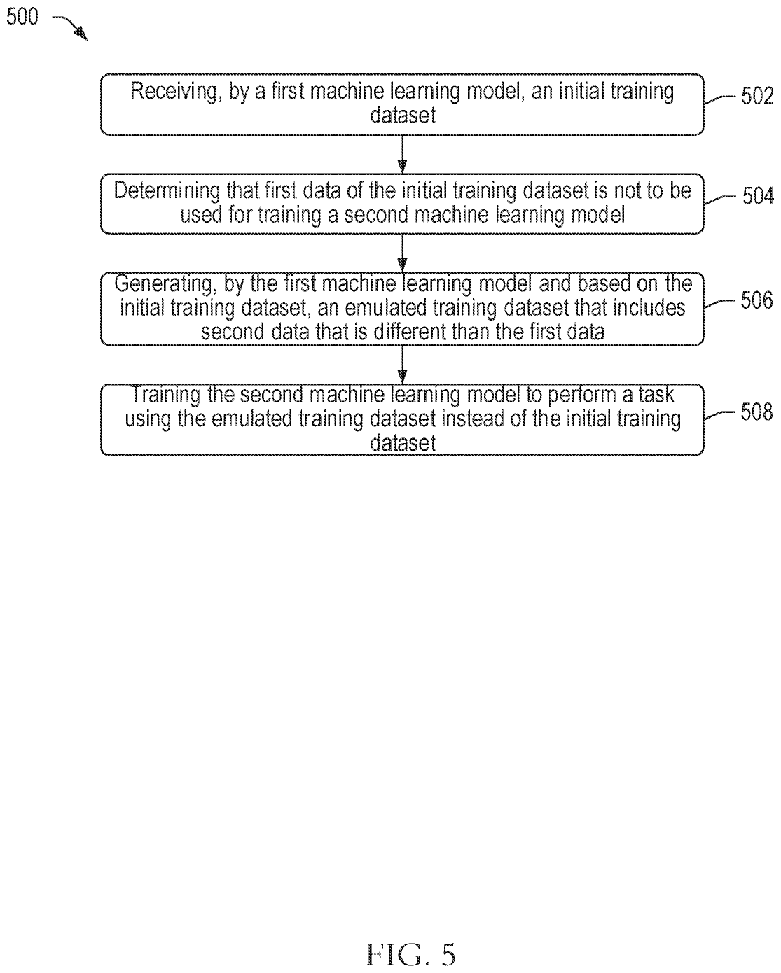

FIG. 5 depicts an example method 500 for training a machine learning model using an emulated dataset. Some or all of the blocks of the process flows or methods in this disclosure may be performed in a distributed manner across any number of devices or systems (for example, user device 701, computing device 704, computing device 800, etc.). The operations of the method 500 may be optional and may be performed in a different order.

At block 502 of the method 500, computer-executable instructions stored on a memory of a system or device, such as, user device 701, computing device 704, computing device 800, etc., may be executed to receive, by a first machine learning model, an initial training dataset. For example, the first machine learning model may be the first generative model 104, 206, 304, 404, etc. That is, the first machine learning model may receive an initial training dataset as an input and may produce an emulated dataset that may ultimately be used to train the machine learning model that is used to perform any downstream tasks. As described herein, the initial training dataset may include any number of different types of data, such as images, videos, text, voice inputs, and/or any other types of data.

At block 504 of the method 500, computer-executable instructions stored on a memory of a system or device may be executed to determine that first data of the initial training dataset is not to be used for training a second machine learning model. That is, the initial training dataset may include at least some data that is either currently undesired to be used for training the machine learning model or has the potential to be undesired for the machine learning model to have knowledge of at a certain point post-training. As one example, the initial training dataset may include user biometric information that is desired to be removed from the training dataset prior to the training dataset being used to train the machine learning model. It may be undesired for certain portions of the initial training dataset to not be used to train the machine learning model for any other reason described herein or otherwise.

At block 506 of the method 500, computer-executable instructions stored on a memory of a system or device may be executed to generate, by the first machine learning model and based on the initial training dataset, an emulated training dataset. The emulated training dataset may be sufficient distance from the initial training dataset such that the portion of the initial training dataset that is undesired to be known by the machine learning model is effectively removed from the training data.

At block 508 of the method 500, computer-executable instructions stored on a memory of a system or device may be executed to train the second machine learning model to perform a task using the emulated training dataset instead of the initial training dataset. That is, the first machine learning model may be used to generate the emulated training dataset and the second machine learning model may then be trained using the emulated training dataset such that the second machine learning model does not have visibility to the portion of the initial training dataset that is undesired to be used for training. The downstream task may be any number of different types of tasks based on the use case for which the second machine learning model is used. For example, the second machine learning model may be trained to perform computer vision tasks, such as identifying people, cars, animals, etc. within images. As another example, the second machine learning model may be trained to perform natural language processing tasks, such as analyzing text or voice-based inquires and providing natural language answers in response to the inquiries. The second machine learning model may also be trained to perform any other type of task or combination of different types of tasks as well.

In embodiments, a feedback loop may also exist that is used to improve the ability of the first generative model to generate an emulated dataset based on an initial training dataset. For example, a generative model may be provided with an initial training dataset along with an indication of certain portions of the initial training dataset that are desired not to be visible to the machine learning model that is trained using the dataset. Once the generative model produces an emulated dataset based on the initial training dataset, a user may manually verify the difference between the emulated training dataset and the initial training dataset and may provide an indication of the verification to the generative model. Alternatively, ground truth data may be provided to the generative model along with the initial training dataset. The ground truth may provide an indication of a sufficiently different emulated training dataset. The generative model may then compare the output it generates to the ground truth to self-train to improve subsequent emulated training datasets that are generated.

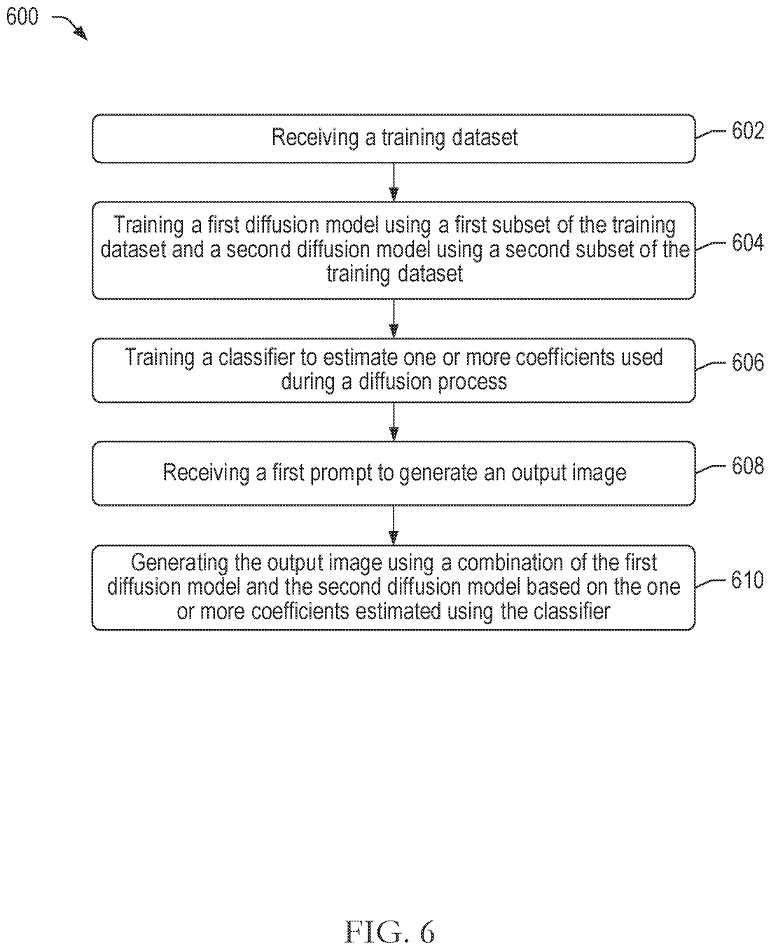

FIG. 6 depicts an example method 600 for training a machine learning model using compartmentalization. Some or all of the blocks of the process flows or methods in this disclosure may be performed in a distributed manner across any number of devices or systems (for example, user device 701, computing device 704, computing device 800, etc.). The operations of the method 600 may be optional and may be performed in a different order.

At block 602 of the method 600, computer-executable instructions stored on a memory of a system or device, such as, user device 701, computing device 704, computing device 800, etc., may be executed to receive a training dataset.

At block 604 of the method 600, computer-executable instructions stored on a memory of a system or device may be executed to train a first diffusion model using a first subset of the training dataset and a second diffusion model using a second subset of the training dataset.

At block 606 of the method 600, computer-executable instructions stored on a memory of a system or device may be executed to train a classifier to estimate one or more coefficients used during a diffusion process.

At block 608 of the method 600, computer-executable instructions stored on a memory of a system or device may be executed to receive a first prompt to generate an output image.

At block 610 of the method 600, computer-executable instructions stored on a memory of a system or device may be executed to generate the output image using a combination of the first diffusion model and the second diffusion model based on the one or more coefficients estimated using the classifier.

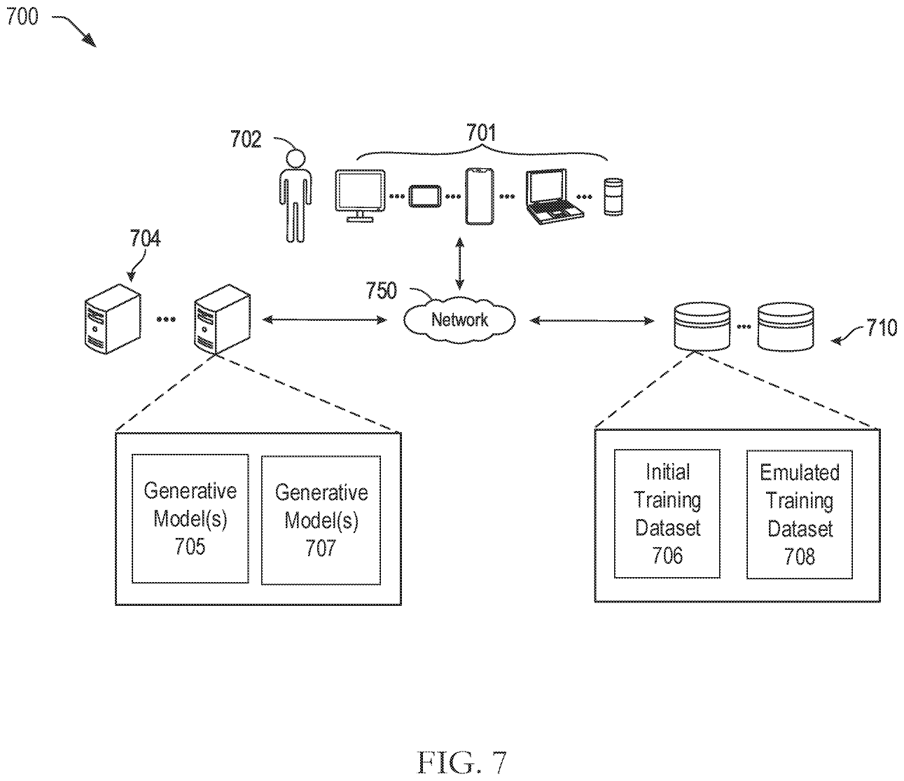

FIG. 7 is an example system 700 for automated analysis of one or more tables. In one or more embodiments, the system may include one or more user devices 701 (which may be associated with one or more users 702), one or more computing devices 704, and/or one or more databases 710. However, these components of the system 700 are merely exemplary and are not intended to be limiting in any way. For simplicity, reference may be made hereinafter to a user device 701, computing device 706, database 712, etc., however, this is not intended to be limiting and may still refer to any number of such elements.

The user device 701 may be any type of device, such as a smartphone, desktop computer, laptop computer, tablet, smart television (for example, a television with Internet connectivity, the capability to install applications, etc.), and/or any other type of device. The user device 701 may allow a user 702 to interact with any of the systems, devices, etc. to perform any number of different types of actions, such as providing training data to a machine learning model, providing inputs (images, videos, text or voice prompts, etc.) to a trained machine learning model to perform downstream tasks, establishing any distance thresholds, providing an indication of certain portions of training data that should be removed for training purposes, etc.

The computing device 704 may be any type of device (such as a local or remote server for example) used to perform any of the processing described herein. For example, the computing device 704 may host any of the models described herein, such as generative model(s) 705 and generative model(s) 707. The different generative model(s) may also be provided across multiple computing devices as well. Additionally, while reference is made herein to generative model(s), any other type of machine learning model may also be used.

In embodiments, the generative model(s) 705 may represent the models that receive the initial training dataset 706 and produce the emulated training dataset 708. For example, the generative model(s) 705 may be the same as generative model 104, 304, etc. The generative model(s) 707 may represent the final machine learning model(s) that are then trained using the emulated training dataset 708 to perform downstream tasks. For example, the generative model(s) 707 may be the same as generative model 108, generative model 308, etc. In this manner, the generative model(s) 707 that is/are used to perform the downstream tasks may not be provided visibility to the initial training dataset 706. This is beneficial in that the generative model(s) 707 may still be trained to perform the downstream tasks without being exposed to certain types of information that may be included in the initial training dataset 706, such as a personally-identifiable information, etc.

As aforementioned, a “downstream task” may refer to any type of task that a model may be trained to perform. For example, the generative model(s) 707 may be trained to identify cars within images that are provided to the generative model(s) 707 as inputs. To train the generative model(s) 707 to perform this task, input images either including cars or not including cars may be provided to the generative model(s) 707 as training data to help the generative model(s) 707 understand how images that include cars appear. The generative model(s) 707 may also be used to perform any other type of task, such as natural language processing and/or any other type of task.

The database 710 may store any of the data that is used as described herein. For example, the database 710 may store the initial training datasets 706 as well as the emulated training datasets 708 that are generated using the initial training datasets 706. In embodiments, the initial training datasets 706 and emulated training datasets 708 may be stored in separate databases to provide a level of separation between the two datasets. Additionally, in embodiments, any of the initial training datasets 706 and emulated training datasets 708 may be deleted from the database 710 after use with the generative model(s) 705 and/or 707. The initial training datasets 706 and emulated training datasets 708 may be the same as any initial training datasets and emulated training datasets described herein or otherwise. For example, the initial training dataset 706 may be the same as initial training dataset 102, 202, 302, etc. and the emulated training dataset 708 may be the same as emulated training dataset 106, 206, 306, etc.

In one or more embodiments, any of the elements of the system 700 (for example, one or more user devices 701, one or more computing devices 704, one or more databases 710, and/or any other element described with respect to FIG. 7 or otherwise) may be configured to communicate via a communications network 750. The communications network 750 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, the communications network 750 may have any suitable communication range associated therewith and may include, for example, global networks (e.g., the Internet), metropolitan area networks (MANs), wide area networks (WANs), local area networks (LANs), or personal area networks (PANs). In addition, communications network 750 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Finally, any of the elements (for example, one or more user devices 701, one or more computing devices 704, and/or one or more databases 710) of the system 700 may include any of the elements of the computing device 800 as well (such as the processor 802, memory 804, etc.).

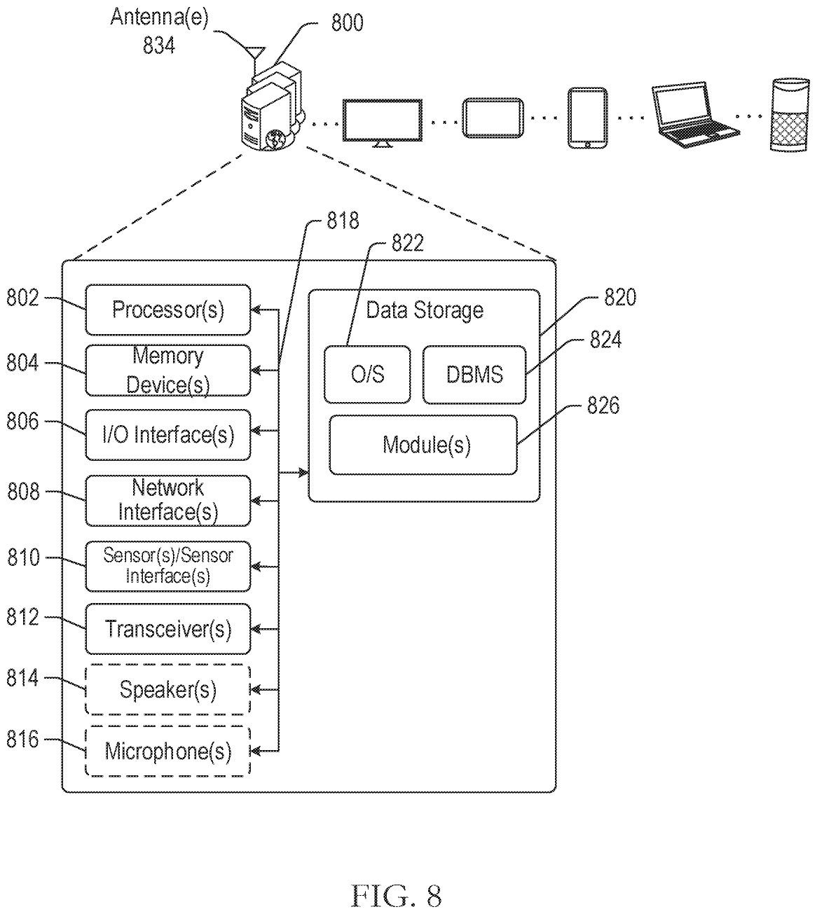

FIG. 8 is a schematic block diagram of an illustrative computing device 800 in accordance with one or more example embodiments of the disclosure. The computing device 800 may include any suitable computing device capable of receiving and/or generating data including, but not limited to, a user device such as a smartphone, tablet, e-reader, wearable device, or the like; a desktop computer; a laptop computer; a content streaming device; a set-top box; or the like. The computing device 800 may correspond to an illustrative device configuration for the devices of FIGS. 1-7 (such as the generative models 104, 108, 206, 304, 308, 404, 408, user device 701, computing device 704, etc.).

The computing device 800 may be configured to communicate via one or more networks with one or more servers, search engines, user devices, or the like. In some embodiments, a single remote server or single group of remote servers may be configured to perform more than one type of content rating and/or machine learning functionality.

Example network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the computing device 800 may include one or more processors (processor(s)) 802, one or more memory devices 804 (generically referred to herein as memory 804), one or more input/output (I/O) interface(s) 806, one or more network interface(s) 808, one or more sensors or sensor interface(s) 810, one or more transceivers 812, one or more optional speakers 814, one or more optional microphones 816, and data storage 820. The computing device 800 may further include one or more buses 818 that functionally couple various components of the computing device 800. The computing device 800 may further include one or more antenna(e) 834 that may include, without limitation, a cellular antenna for transmitting or receiving signals to/from a cellular network infrastructure, an antenna for transmitting or receiving Wi-Fi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. These various components will be described in more detail hereinafter.

The bus(es) 818 may include at least one of a system bus, a memory bus, an address bus, or a message bus, and may permit exchange of information (e.g., data (including computer-executable code), signaling, etc.) between various components of the computing device 800. The bus(es) 818 may include, without limitation, a memory bus or a memory controller, a peripheral bus, an accelerated graphics port, and so forth. The bus(es) 818 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

The memory 804 of the computing device 800 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 804 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 804 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 820 may include removable storage and/or non-removable storage including, but not limited to, magnetic storage, optical disk storage, and/or tape storage. The data storage 820 may provide non-volatile storage of computer-executable instructions and other data. The memory 804 and the data storage 820, removable and/or non-removable, are examples of computer-readable storage media (CRSM) as that term is used herein.

The data storage 820 may store computer-executable code, instructions, or the like that may be loadable into the memory 804 and executable by the processor(s) 802 to cause the processor(s) 802 to perform or initiate various operations. The data storage 820 may additionally store data that may be copied to memory 804 for use by the processor(s) 802 during the execution of the computer-executable instructions. Moreover, output data generated as a result of execution of the computer-executable instructions by the processor(s) 802 may be stored initially in memory 804, and may ultimately be copied to data storage 820 for non-volatile storage.

More specifically, the data storage 820 may store one or more operating systems (O/S) 822; one or more database management systems (DBMS) 824; and one or more program module(s), applications, engines, computer-executable code, scripts, or the like such as, for example, one or more module(s) 826. Any of the components depicted as being stored in data storage 820 may include any combination of software, firmware, and/or hardware. The software and/or firmware may include computer-executable code, instructions, or the like that may be loaded into the memory 804 for execution by one or more of the processor(s) 802. Any of the components depicted as being stored in data storage 820 may support functionality described in reference to correspondingly named components earlier in this disclosure.

The data storage 820 may further store various types of data utilized by components of the computing device 800. Any data stored in the data storage 820 may be loaded into the memory 804 for use by the processor(s) 802 in executing computer-executable code. In addition, any data depicted as being stored in the data storage 820 may potentially be stored in one or more datastore(s) and may be accessed via the DBMS 824 and loaded in the memory 804 for use by the processor(s) 802 in executing computer-executable code. The datastore(s) may include, but are not limited to, databases (e.g., relational, object-oriented, etc.), file systems, flat files, distributed datastores in which data is stored on more than one node of a computer network, peer-to-peer network datastores, or the like. In FIG. 8, the datastore(s) may include, for example, purchase history information, user action information, user profile information, a database linking search queries and user actions, and other information.

The processor(s) 802 may be configured to access the memory 804 and execute computer-executable instructions loaded therein. For example, the processor(s) 802 may be configured to execute computer-executable instructions of the various program module(s), applications, engines, or the like of the computing device 800 to cause or facilitate various operations to be performed in accordance with one or more embodiments of the disclosure. The processor(s) 802 may include any suitable processing unit capable of accepting data as input, processing the input data in accordance with stored computer-executable instructions, and generating output data. The processor(s) 802 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 802 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 802 may be capable of supporting any of a variety of instruction sets.

Referring now to functionality supported by the various program module(s) depicted in FIG. 8, the module(s) 826 may include computer-executable instructions, code, or the like that responsive to execution by one or more of the processor(s) 802 may perform functions including, but not limited to, generation of emulated training datasets, generated trained models based on the emulated training datasets, generating compartmentalized models, etc.

Referring now to other illustrative components depicted as being stored in the data storage 820, the O/S 822 may be loaded from the data storage 820 into the memory 804 and may provide an interface between other application software executing on the computing device 800 and hardware resources of the computing device 800. More specifically, the O/S 822 may include a set of computer-executable instructions for managing hardware resources of the computing device 800 and for providing common services to other application programs (e.g., managing memory allocation among various application programs). In certain example embodiments, the O/S 822 may control execution of the other program module(s) to dynamically enhance characters for content rendering. The O/S 822 may include any operating system now known or which may be developed in the future including, but not limited to, any server operating system, any mainframe operating system, or any other proprietary or non-proprietary operating system.

The DBMS 824 may be loaded into the memory 804 and may support functionality for accessing, retrieving, storing, and/or manipulating data stored in the memory 804 and/or data stored in the data storage 820. The DBMS 824 may use any of a variety of database models (e.g., relational model, object model, etc.) and may support any of a variety of query languages. The DBMS 824 may access data represented in one or more data schemas and stored in any suitable data repository including, but not limited to, databases (e.g., relational, object-oriented, etc.), file systems, flat files, distributed datastores in which data is stored on more than one node of a computer network, peer-to-peer network datastores, or the like. In those example embodiments in which the computing device 800 is a user device, the DBMS 824 may be any suitable light-weight DBMS optimized for performance on a user device.

Referring now to other illustrative components of the computing device 800, the input/output (I/O) interface(s) 806 may facilitate the receipt of input information by the computing device 800 from one or more I/O devices as well as the output of information from the computing device 800 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the computing device 800 or may be separate. The I/O devices may further include, for example, any number of peripheral devices such as data storage devices, printing devices, and so forth.

The I/O interface(s) 806 may also include an interface for an external peripheral device connection such as universal serial bus (USB), FireWire, Thunderbolt, Ethernet port or other connection protocol that may connect to one or more networks. The I/O interface(s) 806 may also include a connection to one or more of the antenna(e) 834 to connect to one or more networks via a wireless local area network (WLAN) (such as Wi-Fi) radio, Bluetooth, ZigBee, and/or a wireless network radio, such as a radio capable of communication with a wireless communication network such as a Long Term Evolution (LTE) network, WiMAX network, 3G network, ZigBee network, etc.

The computing device 800 may further include one or more network interface(s) 808 via which the computing device 800 may communicate with any of a variety of other systems, platforms, networks, devices, and so forth. The network interface(s) 808 may enable communication, for example, with one or more wireless routers, one or more host servers, one or more web servers, and the like via one or more of networks.

The antenna(e) 834 may include any suitable type of antenna depending, for example, on the communications protocols used to transmit or receive signals via the antenna(e) 834. Non-limiting examples of suitable antennas may include directional antennas, non-directional antennas, dipole antennas, folded dipole antennas, patch antennas, multiple-input multiple-output (MIMO) antennas, or the like. The antenna(e) 834 may be communicatively coupled to one or more transceivers 812 or radio components to which or from which signals may be transmitted or received.

As previously described, the antenna(e) 834 may include a cellular antenna configured to transmit or receive signals in accordance with established standards and protocols, such as Global System for Mobile Communications (GSM), 3G standards (e.g., Universal Mobile Telecommunications System (UMTS), Wideband Code Division Multiple Access (W-CDMA), CDMA2000, etc.), 4G standards (e.g., Long-Term Evolution (LTE), WiMax, etc.), direct satellite communications, or the like.

The antenna(e) 834 may additionally, or alternatively, include a Wi-Fi antenna configured to transmit or receive signals in accordance with established standards and protocols, such as the IEEE 802.11 family of standards, including via 2.4 GHz channels (e.g., 802.11b, 802.11g, 802.11n), 5 GHz channels (e.g., 802.11n, 802.11ac), or 60 GHz channels (e.g., 802.11ad). In alternative example embodiments, the antenna(e) 834 may be configured to transmit or receive radio frequency signals within any suitable frequency range forming part of the unlicensed portion of the radio spectrum.

The antenna(e) 834 may additionally, or alternatively, include a GNSS antenna configured to receive GNSS signals from three or more GNSS satellites carrying time-position information to triangulate a position therefrom. Such a GNSS antenna may be configured to receive GNSS signals from any current or planned GNSS such as, for example, the Global Positioning System (GPS), the GLONASS System, the Compass Navigation System, the Galileo System, or the Indian Regional Navigational System.

The transceiver(s) 812 may include any suitable radio component(s) for—in cooperation with the antenna(e) 834—transmitting or receiving radio frequency (RF) signals in the bandwidth and/or channels corresponding to the communications protocols utilized by the computing device 800 to communicate with other devices. The transceiver(s) 812 may include hardware, software, and/or firmware for modulating, transmitting, or receiving—potentially in cooperation with any of antenna(e) 834—communications signals according to any of the communications protocols discussed above including, but not limited to, one or more Wi-Fi and/or Wi-Fi direct protocols, as standardized by the IEEE 802.11 standards, one or more non-Wi-Fi protocols, or one or more cellular communications protocols or standards. The transceiver(s) 812 may further include hardware, firmware, or software for receiving GNSS signals. The transceiver(s) 812 may include any known receiver and baseband suitable for communicating via the communications protocols utilized by the computing device 800. The transceiver(s) 812 may further include a low noise amplifier (LNA), additional signal amplifiers, an analog-to-digital (A/D) converter, one or more buffers, a digital baseband, or the like.

The sensor(s)/sensor interface(s) 810 may include or may be capable of interfacing with any suitable type of sensing device such as, for example, inertial sensors, force sensors, thermal sensors, and so forth. Example types of inertial sensors may include accelerometers (e.g., MEMS-based accelerometers), gyroscopes, and so forth.

The optional speaker(s) 814 may be any device configured to generate audible sound. The optional microphone(s) 816 may be any device configured to receive analog sound input or voice data.

It should be appreciated that the program module(s), applications, computer-executable instructions, code, or the like depicted in FIG. 8 as being stored in the data storage 820 are merely illustrative and not exhaustive and that processing described as being supported by any particular module may alternatively be distributed across multiple module(s) or performed by a different module. In addition, various program module(s), script(s), plug-in(s), Application Programming Interface(s) (API(s)), or any other suitable computer-executable code hosted locally on the computing device 800, and/or hosted on other computing device(s) accessible via one or more networks, may be provided to support functionality provided by the program module(s), applications, or computer-executable code depicted in FIG. 8 and/or additional or alternate functionality. Further, functionality may be modularized differently such that processing described as being supported collectively by the collection of program module(s) depicted in FIG. 8 may be performed by a fewer or greater number of module(s), or functionality described as being supported by any particular module may be supported, at least in part, by another module. In addition, program module(s) that support the functionality described herein may form part of one or more applications executable across any number of systems or devices in accordance with any suitable computing model such as, for example, a client-server model, a peer-to-peer model, and so forth. In addition, any of the functionality described as being supported by any of the program module(s) depicted in FIG. 8 may be implemented, at least partially, in hardware and/or firmware across any number of devices.

It should further be appreciated that the computing device 800 may include alternate and/or additional hardware, software, or firmware components beyond those described or depicted without departing from the scope of the disclosure. More particularly, it should be appreciated that software, firmware, or hardware components depicted as forming part of the computing device 800 are merely illustrative and that some components may not be present or additional components may be provided in various embodiments. While various illustrative program module(s) have been depicted and described as software module(s) stored in data storage 820, it should be appreciated that functionality described as being supported by the program module(s) may be enabled by any combination of hardware, software, and/or firmware. It should further be appreciated that each of the above-mentioned module(s) may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other module(s). Further, one or more depicted module(s) may not be present in certain embodiments, while in other embodiments, additional module(s) not depicted may be present and may support at least a portion of the described functionality and/or additional functionality. Moreover, while certain module(s) may be depicted and described as sub-module(s) of another module, in certain embodiments, such module(s) may be provided as independent module(s) or as sub-module(s) of other module(s).

Program module(s), applications, or the like disclosed herein may include one or more software components including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

That which is claimed is:

1. A method comprising:
receiving, by a first generative machine learning model, an initial training dataset;
determining that the initial training dataset includes first data that is indicated not to be used for training a second machine learning model;
generating, by the first generative machine learning model and based on the initial training dataset, an emulated training dataset that includes second data that is different than the first data;
comparing the emulated training dataset and the initial training dataset;
determining, based on the comparison, that a distance between the first data and the second data satisfies a threshold value; and
training, based on determining that the distance satisfies the threshold value, the second machine learning model to perform a task using the emulated training dataset instead of the initial training dataset.

2. The method of claim 1, further comprising:
generating a natural language description of the initial training dataset, wherein generating the emulated training dataset is based on the natural language description instead of the initial training dataset.

3. The method of claim 1, wherein determining that the first data is not to be used for training the second machine learning model is based on an indication from a user.

4. The method of claim 1, wherein a portion of first data is maintained in the second data.

5. A method comprising:
receiving, by a first machine learning model, an initial training dataset;
determining that first data of the initial training dataset is not to be used for training a second machine learning model;
generating, by the first machine learning model and based on the initial training dataset, an emulated training dataset that includes second data that is different than the first data; and
training the second machine learning model to perform a task using the emulated training dataset instead of the initial training dataset.

6. The method of claim 5, wherein the first machine learning model is a generative machine learning model.

7. The method of claim 5, further comprising:
generating a natural language description of the initial training dataset, wherein generating the emulated training dataset is based on the natural language description instead of the initial training dataset.

8. The method of claim 5, further comprising:
verifying that a threshold difference exists between the first data and the second data prior to training the second machine learning model using the emulated training dataset.

9. The method of claim 8, wherein verifying that the threshold difference exists further comprises determining that a distance between the first data and second data satisfies a threshold value.

10. The method of claim 5, wherein determining that the first data is not to be used for training the second machine learning model is based on an indication from a user.

11. The method of claim 5, wherein a portion of first data is maintained in the second data.

12. The method of claim 5, wherein the initial training dataset includes one or more images, wherein the first data includes biometric information included in the one or more images, and wherein the second data lacks the biometric information.

13. A system comprising:
memory that stores computer-executable instructions; and
one or more processors configured to access the memory and execute the computer-executable instructions to:
receive, by a first machine learning model, an initial training dataset;
determine that first data of the initial training dataset is not to be used for training a second machine learning model;
generate, by the first machine learning model and based on the initial training dataset, an emulated training dataset that includes second data that is different than the first data; and
train the second machine learning model to perform a task using the emulated training dataset instead of the initial training dataset.

14. The system of claim 13, wherein the first machine learning model is a generative machine learning model.

15. The system of claim 13, wherein the one or more processors are further configured to execute the computer-executable instructions to:
generate a natural language description of the initial training dataset, wherein generating the emulated training dataset is based on the natural language description instead of the initial training dataset.

16. The system of claim 13, wherein the one or more processors are further configured to execute the computer-executable instructions to:
verify that a threshold difference exists between the first data and the second data prior to training the second machine learning model using the emulated training dataset.

17. The system of claim 16, wherein verifying that the threshold difference exists further comprises determining that a distance between the first data and second data satisfies a threshold value.

18. The system of claim 13, wherein determining that the first data is not to be used for training the second machine learning model is based on an indication from a user.

19. The system of claim 13, wherein a portion of first data is maintained in the second data.

20. The system of claim 13, wherein the initial training dataset includes one or more images, wherein the first data includes biometric information included in the one or more images, and wherein the second data lacks the biometric information.
